(19) United States
(12) Patent Application Publication
(10) Pub. No.: US 2009/0102873 A1
(43) Pub. Date: Apr. 23, 2009

(54) LIQUID EJECTING APPARATUS AND LIQUID EJECTING METHOD

(75) Inventor: Toshihiro HAYASHI, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/255,779

(22) Filed: Oct. 22, 2008

(30) Foreign Application Priority Data
Oct. 23, 2007 (JP) 2007-274741
Oct. 23, 2007 (JP) 2007-274742
Oct. 26, 2007 (JP) 2007-278539
Jul. 8, 2008 (JP) 2008-177603

(51) Int. Cl. B41J 25/308

(52) U.S. Cl. 347/8

(57) ABSTRACT

A liquid ejecting apparatus includes a first nozzle, a second nozzle, an image formation control unit, a latent image formation control unit, and a position detection unit. The first nozzle ejects a first liquid droplet for forming an image on a recording medium. The second nozzle ejects a second liquid droplet that is transparent to visible light for forming a latent image on the recording medium. The image formation control unit, during the relative movement, ejects the first liquid droplet onto the recording medium to thereby form an image pattern. The latent image formation control unit ejects the second liquid droplet onto the recording medium so as to overlap the image pattern to thereby form a latent image pattern. The position detection unit recognizes the latent image pattern as a reference position on the recording medium and detects a relative position between the recording medium and the first nozzle.

### BACKGROUND

1. Technical Field

The present invention relates to a liquid ejecting apparatus and a liquid ejecting method.

2. Related Art

An ink jet printer forms an image by ejecting ink as liquid droplets while alternately repeating transportation of a recording medium such as a sheet of paper and main scanning by which a carriage is moved in a direction perpendicular to the transport direction of the sheet of paper. In the ink jet printer, a recording medium is moved through subscanning, by which a motor is driven to transport the recording medium, between preceding main scanning and the following main scanning on the basis of a predetermined amount of feed. At the time of subscanning, if the amount of feed by which a recording medium is actually transported deviates from the predetermined amount of feed, a white stripe or uneven color will arise on an image formed on the recording medium. For example, the frictional force that acts between a recording medium and rollers that transport the recording medium varies depending on the material of the recording medium. Thus, if the material of the recording medium is changed, the amount of feed by which the recording medium is actually transported may deviate from the predetermined amount of feed at the time of subscanning. In addition, when the subscanning performed between preceding main scanning and the following main scanning is repeated to form an image, a deviation in amount of feed in each subscanning accumulates and, as a result, a deviation in amount of feed of the recording medium in the transport direction may be multiplied. For example, in an ink jet printer that forms an image by ejecting liquid droplets onto a large-sized recording medium, such as A1 in paper size, in order to increase a print speed, a head having a long length of a nozzle array in the transport direction is employed to thereby increase the predetermined amount of feed in which the recording medium is moved for each subscanning. When the predetermined amount of feed is increased and subscanning is repeated to form an image, a deviation in amount of feed in each subscanning accumulates and, as a result, a deviation in amount of feed of the recording medium in the transport direction is multiplied. Then, for example, JP-A-2001-146051 suggests a method in which ink is discharged from one nozzle located upstream out of two nozzles aligned in the transport direction to form a first image, a recording medium is moved in the transport direction by the distance in the transport direction between the two nozzles, then ink is discharged from the other nozzle located downstream to form a second image, a deviation in position between the first image and the second image is read and detected by a scanner, and then the predetermined amount of feed is corrected.

In order to accurately form an image, however, in advance of printing a desired image, it is necessary to detect a deviation in amount of feed beforehand and then correct the deviation. For this reason, in addition to the recording medium on which a desired image is printed, it is necessary to prepare beforehand another recording medium on which printing is performed in order to detect a deviation in amount of feed. Furthermore, the user needs, in addition to time for operating a liquid ejecting apparatus in order to print out a desired image, work time for operating the liquid ejecting apparatus in advance in order to detect a deviation in amount of feed and correct the deviation.

### SUMMARY

An advantage of some aspects of the invention may be obtained by implementing the aspects of the invention in the following forms or application examples.

### FIRST APPLICATION EXAMPLE

An aspect of the invention provides a liquid ejecting apparatus. The liquid ejecting apparatus includes a first nozzle, a second nozzle, an actuator unit, an image formation control unit, a latent image formation control unit, and a position detection unit. The first nozzle ejects a first liquid droplet for forming an image on a recording medium. The second nozzle ejects a second liquid droplet that is transparent to visible light for forming a latent image on the recording medium. The actuator unit performs relative movement between the recording medium and the first nozzle. The image formation control unit, during the relative movement, ejects the first liquid droplet onto the recording medium to thereby form an image pattern. The latent image formation control unit ejects the second liquid droplet onto the recording medium so as to overlap the image pattern to thereby form a latent image pattern. The position detection unit recognizes the latent image pattern as a reference position on the recording medium and detects a relative position between the recording medium and the first nozzle. The image formation control unit controls the relative movement on the basis of the relative position detected by the position detection unit.

According to the above configuration, the second liquid droplet is ejected onto the recording medium so as to overlap the image pattern to thereby form the latent image pattern, the latent image pattern is recognized as the reference position on the recording medium, and then the relative position between the recording medium and the first nozzle is detected. Thus, without requiring work time for operating a recording medium to be printed or the liquid ejecting apparatus in advance, it is possible to accurately form an image.

### SECOND APPLICATION EXAMPLE

In the liquid ejecting apparatus according to the aspect of the invention, the position detection unit may include an imaging unit that picks up the latent image pattern as a real image pattern and a positional difference detection unit that, in a field of view of the imaging unit, detects a positional difference between the real image pattern and a template pattern.

According to the above configuration, by detecting the positional difference between the real image pattern and the template pattern, it is possible to detect a deviation in amount of feed.

### THIRD APPLICATION EXAMPLE

In the liquid ejecting apparatus according to the aspect of the invention, the latent image formation control unit may control formation of the latent image pattern so that the latent image pattern is located within the field of view of the imaging unit after one relative movement is performed. According to the above configuration, formation of a latent image pattern is controlled so that the latent image pattern is located within the field of view of the imaging unit. By so doing, because the latent image pattern may be picked up as a real image pattern by the imaging unit, it is possible to detect a deviation in amount of feed from the real image pattern.

### FOURTH APPLICATION EXAMPLE

In the liquid ejecting apparatus according to the aspect of the invention, the image formation control unit may execute feedback correction of the amount of movement in regard to the relative movement. According to the above configuration, the accuracy of the amount of feed improves to thereby make it possible to improve the image quality.

### FIFTH APPLICATION EXAMPLE

The liquid ejecting apparatus according to the aspect of the invention may further include an irradiation unit that irradiates light of a first wavelength range to the latent image pattern; and an image conversion unit that selectively receives light of a second wavelength range, which is emitted from the latent image pattern by irradiating light of the first wavelength range, and that converts the received light of the second wavelength range into image data, wherein the second liquid droplet may contain a wavelength conversion material that, when light of the first wavelength range enters the wavelength conversion material, emits light of the second wavelength range that is different from the first wavelength range.

According to the above configuration, light of the second wavelength range emitted from the latent image pattern is selectively received, and is converted into the image data. By so doing, it is possible to reduce the influence of natural light or light of the first wavelength range that is reflected around the latent image pattern. Thus, because it is possible to suppress a decrease in quality of the converted image data, it is possible to highly accurately read the position of the latent image pattern formed on the recording medium.

### SIXTH APPLICATION EXAMPLE

In the liquid ejecting apparatus according to the aspect of the invention, the wavelength conversion material may be a fluorescent substance. According to the above configuration, when light of the first wavelength range enters the latent image pattern formed by ejecting a liquid droplet that contains a fluorescent substance onto the recording medium, it is possible to emit light of the second wavelength range that is different from the first wavelength range. By so doing, it is possible to reduce the influence of natural light or light of the first wavelength range that is reflected around the latent image pattern.

### SEVENTH APPLICATION EXAMPLE

In the liquid ejecting apparatus according to the aspect of the invention, light of the first wavelength range may be an ultraviolet ray. According to the above configuration, when an ultraviolet ray is irradiated to the latent image pattern formed by ejecting liquid droplets that contain the wavelength conversion material, it is possible to emit light of the second wavelength range that is different from the wavelength of the ultraviolet ray.

### EIGHTH APPLICATION EXAMPLE

In the liquid ejecting apparatus according to the aspect of the invention, the image conversion unit may cut light of the first wavelength range and transmit light of the second wavelength range. According to the above configuration, the image conversion unit selectively receives light of the second wavelength range emitted from the latent image pattern to thereby make it possible to reduce the influence of natural light or light of the first wavelength range that is reflected around the latent image pattern.

### NINTH APPLICATION EXAMPLE

In the liquid ejecting apparatus according to the aspect of the invention, the latent image formation control unit may relatively move the recording medium in a first direction with respect to a head in which the second nozzle is provided while ejecting a liquid droplet from the head onto the recording medium to thereby form the latent image pattern that includes a plurality of marks arranged successively in a second direction perpendicular to the first direction.

According to the above configuration, owing to the plurality of marks that are arranged successively in the second direction perpendicular to the first direction, it is possible to detect a deviation in amount of feed of the recording medium in the second direction perpendicular to the first direction.

### TENTH APPLICATION EXAMPLE

In the liquid ejecting apparatus according to the aspect of the invention, the position detection unit, during changes in relative position component between the image data, which are detected data of the marks, and template data, may calculate a variation in the relative position component when the logical product of the image data and the template data takes an extreme value.

According to the above configuration, by calculating a variation in relative position component when the logical product of the image data and the template data takes an extreme value, it is possible to detect a deviation in amount of feed of the recording medium in the second direction perpendicular to the first direction.

### ELEVENTH APPLICATION EXAMPLE

In the liquid ejecting apparatus according to the aspect of the invention, the positional difference detection unit may detect a difference between positions of the plurality of marks that constitute the image data and positions of the template data that are arranged in the same manner as the plurality of marks in the image field of view of the image conversion unit.

According to the above configuration, by detecting a difference between the positions of the plurality of marks that constitute the image data and the positions of the template data that are arranged in the same manner as the plurality of marks, it is possible to detect a deviation in amount of feed in the transport direction while printing. Thus, the user does not need work time for operating the liquid ejecting apparatus in order to detect a deviation in amount of feed and correct the deviation in advance, in addition to time for operating the liquid ejecting apparatus in order to print out a desired image.

### TWELFTH APPLICATION EXAMPLE

In the liquid ejecting apparatus according to the aspect of the invention, the latent image pattern may be formed so that the plurality of marks are arranged in a grid in a transport direction and in a vertical direction.

According to the above configuration, by arranging the plurality of marks in a grid in the transport direction and in the vertical direction, it is possible to detect a relative position between the image data and the template data as a deviation in the transport direction and a deviation in the vertical direction relative to the transport direction. By so doing, it is possible to detect a deviation in amount of feed of a recording medium in the transport direction and a deviation in amount of feed of the recording medium in the vertical direction relative to the transport direction.

### THIRTEENTH APPLICATION EXAMPLE

In the liquid ejecting apparatus according to the aspect of the invention, the latent image formation control unit may form the latent image pattern formed of a plurality of mark groups, and may arrange marks so that, in a plurality of columns or rows in the same direction in each mark group, the number of marks in at least one column or row is different from the number of marks in the other columns or rows, and then the positional difference detection unit may calculate the sum total of pixels picked up from the image field of view in the same direction.

According to the above configuration, by calculating the sum total of pixels of the image field of view in the same direction, the sum total of pixels in at least one column or row is different from the sum total of pixels in the other columns or rows. Thus, it is possible to recognize the at least one column or row that is different in number of marks from the other columns or rows. By so doing, it is possible to detect a deviation in amount of feed of a recording medium in the transport direction and a deviation in amount of feed of the recording medium in the vertical direction relative to the transport direction.

### FOURTEENTH APPLICATION EXAMPLE

In the liquid ejecting apparatus according to the aspect of the invention, the positional difference detection unit may calculate comparison values by performing the product of the sum total of image data and the sum total of template data at the same position in the transport direction in the transport direction, may shift a relative position between the image data and the template data, and may calculate a displacement by which the relative position is shifted to a position at which the total of the comparison values reaches a maximum value.

According to the above configuration, by calculating a displacement by which the relative position is shifted to a position at which the comparison values reach the maximum value, in the image field of view, a displacement from a position at which the image data deviate from the template data to a position at which the image data coincide with the template data, that is, a positional difference, is calculated. By so doing, it is possible to detect a deviation in amount of feed of a recording medium in the transport direction and a deviation in amount of feed of the recording medium in the vertical direction relative to the transport direction.

### FIFTEENTH APPLICATION EXAMPLE

In the liquid ejecting apparatus according to the aspect of the invention, the latent image formation control unit may arrange a mark, which is different from a plurality of marks formed in the same arrangement, at a position different among each mark group.

According to the above configuration, by arranging a mark at a different position among each mark group, it is possible to separately identify a mark group. Thus, in the transport direction, even when a deviation in amount of feed exceeds a distance of one mark group in the transport direction, it is possible to detect a deviation in amount of feed of the recording medium in the transport direction and a deviation in amount of feed of the recording medium in the vertical direction relative to the transport direction.

### SIXTEENTH APPLICATION EXAMPLE

Another aspect of the invention provides a liquid ejecting method. The liquid ejecting method includes ejecting a first liquid droplet from a first nozzle onto a recording medium for forming an image; ejecting a second liquid droplet, which is transparent to visible light, from a second nozzle onto the recording medium for forming a latent image; performing relative movement between the recording medium and the first nozzle; during the relative movement, ejecting the first liquid droplet onto the recording medium to form an image pattern; ejecting the second liquid droplet onto the recording medium so as to overlap the image pattern to form a latent image pattern; and recognizing the latent image pattern as a reference position on the recording medium and detecting a relative position between the recording medium and the first nozzle, wherein when the image pattern is formed on the recording medium, the relative movement is controlled on the basis of the detected relative position.

### SEVENTEENTH APPLICATION EXAMPLE

The liquid ejecting method may further include irradiating light of a first wavelength range to the latent image pattern; and selectively receiving light of a second wavelength range, which is emitted from the latent image pattern by irradiating light of the first wavelength range, and then converting light of the second wavelength range into image data, wherein the second liquid droplet may contain a wavelength conversion material that, when light of the first wavelength range enters the wavelength conversion material, emits light of the second wavelength range that is different from the first wavelength range.

### EIGHTEENTH APPLICATION EXAMPLE

In the liquid ejecting method according to the aspect of the invention, when the latent image pattern is formed, the recording medium may be relatively moved in a first direction with respect to a head having the second nozzle while ejecting a liquid droplet from the head onto the recording medium to thereby form a latent image pattern having a plurality of marks that are arranged successively in a second direction perpendicular to the first direction.

### BRIEF DESCRIPTION OF THE DRAWINGS

The invention will be described with reference to the accompanying drawings, wherein like numbers reference like elements.

FIG. 1 is an external perspective view of an ink jet printer according to an embodiment.

FIG. 2 is a view that illustrates the internal appearance of the ink jet printer.

FIG. 3 is a block diagram that shows the electrical configuration of the ink jet printer.

FIG. 4 is an external view that illustrates the positional relationship between a camera and a head.

FIG. 5A is a view that shows the head provided with nozzles that eject a transparent ink.

FIG. 5B is a view showing that a nozzle array that ejects a transparent ink is provided on each side of nozzle arrays that eject colored inks.

FIG. 6 is a view that illustrates the camera and irradiation units.

FIG. 7 is a view that shows a latent image pattern that a latent image formation control unit forms.

FIG. 8 is a view that shows converted image data.

FIG. 9 is a schematic view that illustrates a deviation in amount of feed in a Y direction.

FIG. 10A is a view that illustrates a case in which image data and template data do not coincide with each other in position in the Y direction in an image field of view of the camera.

FIG. 10B is a view that illustrates a case in which image data and template data coincide with each other in position in the Y direction in the image field of view of the camera.

FIG. 11A is a view of the waveform that shows changes in total of comparison values when the position of the image data in the Y direction is changed within the image field of view.

FIG. 11B is a view of the waveform that shows changes in total of comparison values when the position of the image data in the X direction is changed within the image field of view.

FIG. 12 is a view that shows values obtained by totaling the image data pixel by pixel in the Y direction as levels in the Y direction.

FIG. 13 is a view showing that marks that constitute a latent image pattern are arranged in a grid.

FIG. 14 is a view that illustrates the positions of marks that constitute the image data and the positions of marks that constitute the template data within a portion of the range of the latent image pattern.

FIG. 15 is a flowchart that shows the flow of processes until a deviation in the Y direction is detected.

FIG. 16 is a view that shows a plurality of marks that constitute a cluster as one group.

FIG. 17 is a view that shows a latent image pattern formed on a sheet of paper.

FIG. 18 is a view that shows converted image data and the waveform of the sum total of levels in the X direction.

FIG. 19 is a view that shows the converted image data and the waveform of the sum total of levels in the Y direction.

FIG. 20 is a view showing that a mark by which a cluster is identified is formed in a cluster, which serves as a group of marks.

FIG. 21A and FIG. 21B are views showing that a mark by which a cluster is identified is formed in the cluster.

FIG. 22 is a view that shows a latent image pattern formed at each end portion of a sheet of paper in the X direction.

FIG. 23 is a view that illustrates a method by which a deviation in the Y direction is detected according to the embodiment.

FIG. 24 is a view showing that a piezoactuator that moves the head in the transport direction is provided.

FIG. 25 is a view showing that the function of rotating the head is added.

### DESCRIPTION OF EXEMPLARY EMBODIMENTS

Hereinafter, embodiments of the invention will be described with reference to the accompanying drawings.

### First Embodiment

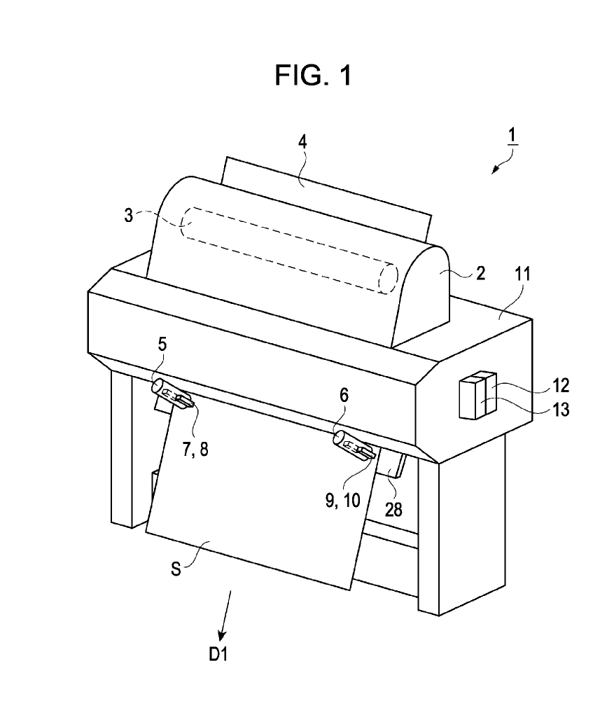

FIG. 1 is an external perspective view of an ink jet printer 1, which serves as a liquid ejecting apparatus, according to the present embodiment. A roll sheet 3, which serves as a recording medium, covered with an upper cover 2, is provided in the ink jet printer 1. The ink jet printer 1 is able to feed a cut sheet (not shown), which serves as a recording medium, from a paper guide 4. The ink jet printer 1 is able to eject a sheet of paper S, which may be the roll sheet 3 or the cut sheet, from an opening, provided at the lower portion of the ink jet printer 1, in a transport direction D1.

A detachable ink cartridge 12 that is filled with colored inks (yellow, magenta, cyan, and black), which serve as first liquid droplets, and an ink cartridge 13 that is filled with an ink, which serves as liquid droplets transparent to visible light, are provided on the side face of the ink jet printer 1. The colored inks and the transparent ink are supplied through tubes to a head (not shown) provided inside a main unit cover 11.

The transparent ink contains a fluorescent substance, which serves as a wavelength conversion material. As the fluorescent substance of the present embodiment is irradiated with an ultraviolet ray serving as light of a first wavelength range, the fluorescent substance reflects green light having a wavelength range different from that of the ultraviolet ray, as light of a second wavelength range.

Cameras 5 and 6 are provided on the front face of the ink jet printer 1, and irradiation units 7 and 8 and irradiation units 9 and 10, which irradiate ultraviolet ray, are respectively provided for the camera 5 and the camera 6.

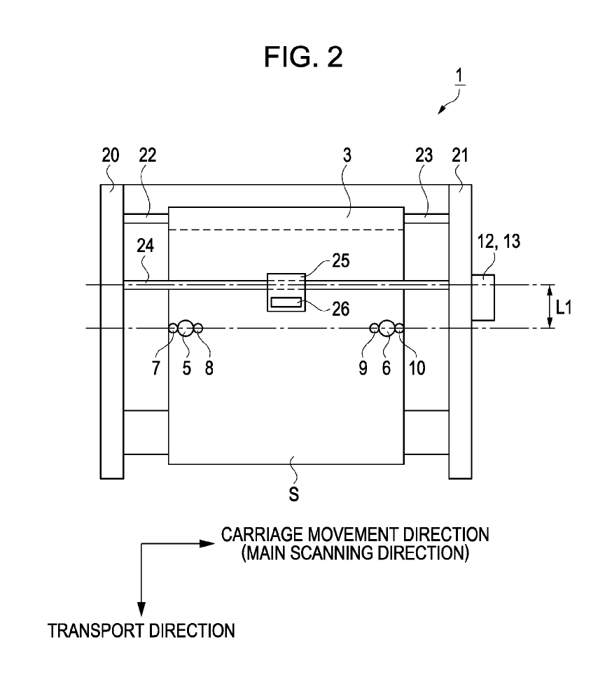

FIG. 2 is a view that illustrates the internal appearance of the ink jet printer 1 by removing the upper cover 2 and the main unit cover 11. A carriage 25 is connected to a timing belt (not shown) that rotates with rotation of a carriage drive motor (not shown), and reciprocally moves along a sliding shaft 24 in a direction perpendicular to the transport direction of the sheet of paper S (hereinafter, simply referred to as transport direction). A head 26 is provided for the carriage 25. With reciprocal movement of the carriage 25, the head 26 reciprocally moves in the direction perpendicular to the transport direction. Movement of the head 26 to one side in the direction perpendicular to the transport direction is called main scanning, and the direction perpendicular to the transport direction is called a main scanning direction.

The roll sheet 3 is rotatably supported by rotary shafts 22 and 23 provided on left and right cases 20 and 21. A paper feed rollers (not shown) that is driven by a paper feed motor (not shown) and a freely rotatable driven roller (not shown) are provided upstream of the head 26 in the transport direction so as to place the sheet of paper S in between, and the sheet of paper S is fed by these rollers. A paper ejection roller (not shown) that rotates in association with driving of the paper feed motor and a freely rotatable driven roller are provided downstream of the head 26 in the transport direction so as to place the sheet of paper S in between, and the sheet of paper S is ejected by these rollers.

The carriage 25 is provided with a linear encoder (not shown) that outputs a pulse signal corresponding to the amount of movement in the main scanning direction, and the position of the head 26 in the main scanning direction may be controlled. The paper feed motor is provided with a rotary encoder (not shown) that outputs a pulse signal corresponding to the amount of rotation, and the amount of feed of the sheet of paper S in the transport direction in subscanning, which is performed between preceding main scanning and the following main scanning, may be controlled.

The camera 5 and the irradiation units 7 and 8 are provided at the left end portion of the sheet of paper S in the paper width direction in the drawing, and the camera 6 and the irradiation units 9 and 10 are provided at the right end portion. The distance L1 in the transport direction from the center of the sliding shaft 24 to the center of the cameras 5 and 6 is regularly held at constant.

In the present embodiment, the cameras 5 and 6 are located at a position to which an image formed by ejecting ink from the head 26 to the sheet of paper S is moved in the transport direction by repeating subscanning multiple times. With the above location, it is possible to detect a deviation that is obtained so that a deviation in amount of feed of the sheet of paper S in each subscanning is accumulated over multiple times.

The ink cartridges 12 and 13 are provided on the right side case 21 in the drawing as described above, and the head 26 is supplied with the colored inks and the transparent ink from the ink cartridges 12 and 13. The ink jet printer 1 repeatedly moves the sheet of paper S in the transport direction and reciprocally moves the head 26 in the direction perpendicular to the transport direction, while making it possible to form a visible image by ejecting colored inks and form an invisible latent image by ejecting a transparent ink.

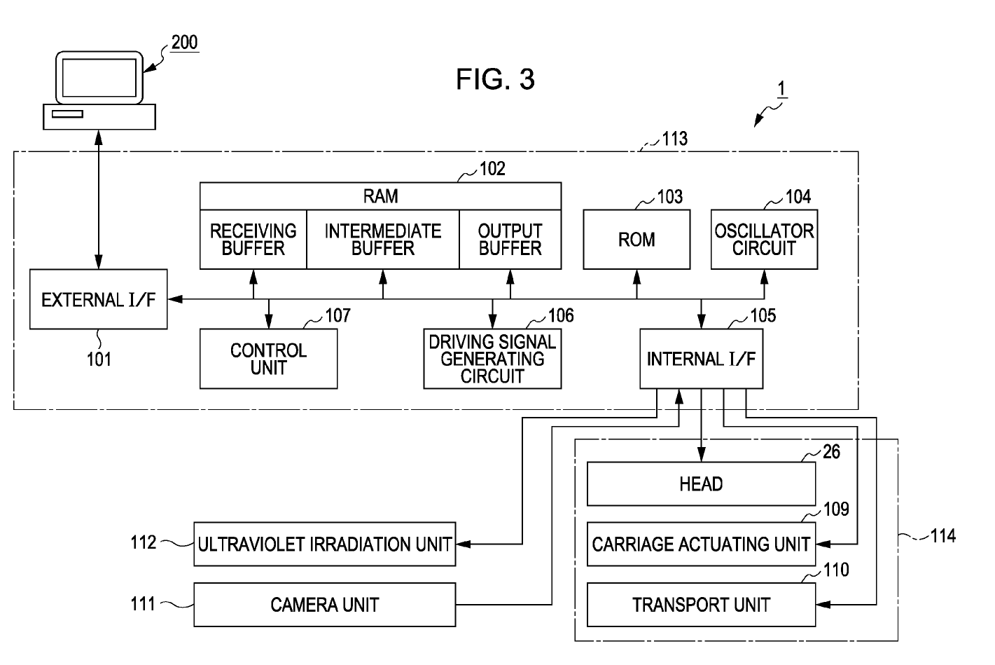

FIG. 3 is a block diagram that shows the electrical configuration of the ink jet printer 1. The ink jet printer 1 schematically includes a printer controller 113, a print engine 114, an ultraviolet irradiation unit 112, and a camera unit 111.

The printer controller 113 includes an external interface (I/F) 101, a RAM 102, a ROM 103, a control unit 107, an oscillator circuit 104, a driving signal generating circuit 106, and an internal interface (I/F) 105. The external I/F 101 is input with print data, and the like, from a host computer 200, which is an external device. The RAM 102 stores various types of data, and the like. The ROM 103 stores control routines, or the like, for various types of data processing. The control unit 107 is formed of a CPU, and the like. The driving signal generating circuit 106 generates a driving signal supplied to the head 26. The internal I/F 105 is used for outputting, to the print engine 114, printing dot data obtained by expanding the print data by dots, the driving signal, and the like.

The control unit 107 also serves as a control unit in the present embodiment. The control unit 107 controls movement of the carriage 25 (head 26) in the main scanning direction by a carriage actuating unit 109 and transportation of the sheet of paper S in the transport direction by a transport unit 110, while controlling ejection of ink by the head 26.

The control unit 107 performs subscanning in which the sheet of paper S is moved in the transport direction in a period between preceding main scanning and the following main scanning by driving the paper feed motor on the basis of the predetermined amount of feed stored in the ROM 103.

The print engine 114 includes the head 26, the carriage actuating unit 109 and the transport unit 110. The carriage actuating unit 109 includes the carriage drive motor and the linear encoder. The transport unit 110 includes the paper feed motor, the rotary encoder, and a detector (not shown) that detects feeding and ejection of a sheet of paper S.

The ultraviolet irradiation unit 112 includes the irradiation units 7, 8, 9, and 10 shown in FIG. 2. The camera unit 111 includes the cameras 5 and 6 shown in FIG. 2.

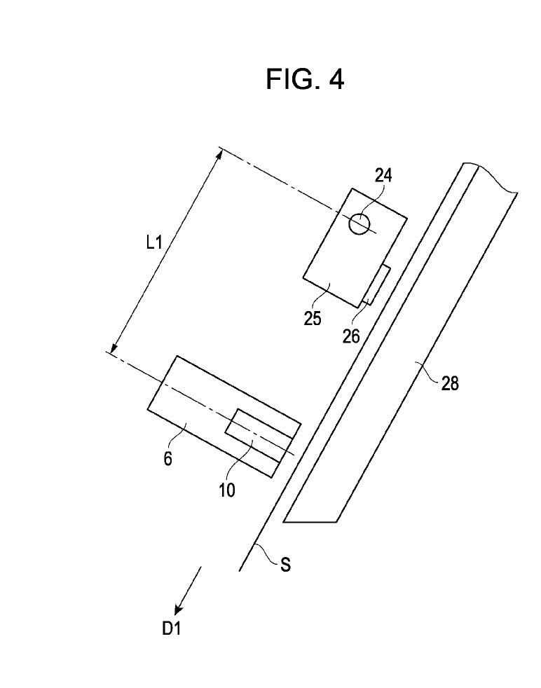

FIG. 4 is an external view that illustrates the positional relationship between the camera 6 and the head 26, which are provided at the right end portion of the sheet of paper S in FIG. 2. FIG. 4 is a view of the ink jet printer 1 as seen from the right end in FIG. 2. The sheet of paper S is transported on a platen 28 in the transport direction D1. The carriage 25 having the head 26 reciprocally moves along the sliding shaft 24 in the vertical direction to the drawing. The irradiation unit 10 provided on the side face of the camera 6 irradiates an ultraviolet ray to a position at which the camera 6 faces the sheet of paper S.

The distance L1 from the center line of the camera 6 to the center line of the sliding shaft 24 is held at constant. Thus, the distance between the camera 6 and the head 26 provided on the carriage 25 that slides on the sliding shaft 24 is also held at constant.

The distance between the center of the sliding shaft 24 and the center of the camera 5 provided at the left end portion of the sheet of paper S in FIG. 2 is also similarly held at constant, that is, at the distance L1, and the distance between the camera 5 and the head 26 is also held.

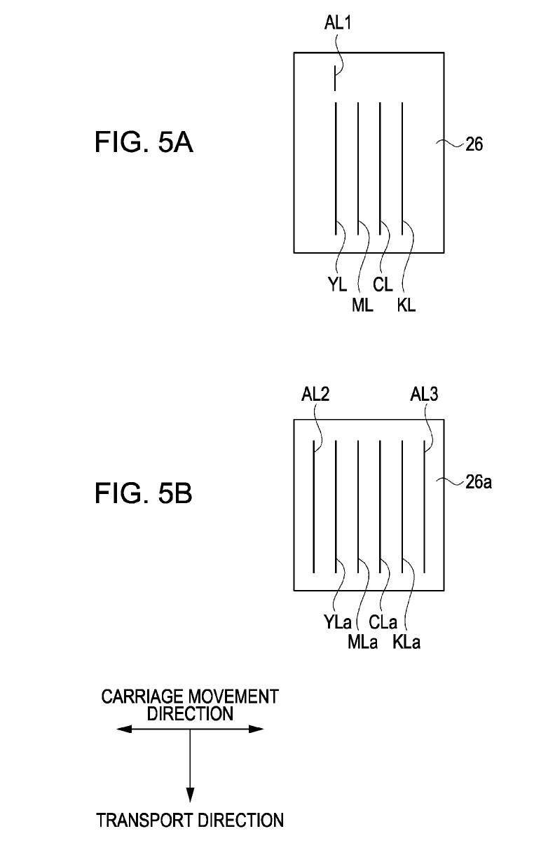

FIG. 5A is a view that shows the head 26 provided with nozzles for ejecting ink that is transparent to visible light. The head 26 has nozzle arrays YL, ML, CL, and KL that are formed of nozzles, which serve as first nozzles, for ejecting inks colored in yellow, magenta, cyan, and black, respectively. A nozzle array AL1 formed of second nozzles for ejecting a transparent ink is formed on the upstream side of the nozzle arrays YL, ML, CL, and KL in the transport direction. The transparent ink ejected from the nozzle array AL1 contains a fluorescent substance, which serves as a wavelength conversion material. As the fluorescent substance of the present embodiment is irradiated with an ultraviolet ray, the fluorescent substance reflects green light. When the nozzle array AL1 is provided upstream of the nozzle arrays YL, ML, CL, and KL, colored inks are ejected from the nozzle arrays YL, ML, CL, and KL, the head 26 is moved in the transport direction and then a transparent ink is ejected from the nozzle array AL1. Thus, when an image is formed by ejecting a transparent ink so as to overlap an image formed by ejecting colored inks, it is possible to ensure time until colored inks solidify.

A nozzle array that ejects a transparent ink may be provided on each side of the nozzle arrays that eject colored inks. FIG. 5B is a view showing that a nozzle array that ejects a transparent ink is provided on each side of the nozzle arrays that eject colored inks. A head 26a has nozzle arrays YLa, MLa, CLa, and KLa that eject inks that are respectively colored in yellow, magenta, cyan, and black. Nozzle arrays AL2 and AL3 that eject a transparent ink are respectively formed on both sides of the nozzle arrays YLa, MLa, CLa, and KLa in the carriage movement direction. The nozzle array AL2, when the head 26a ejects colored inks while being moved to the right side in the drawing, ejects a transparent ink after colored inks have been ejected. Similarly, the nozzle array AL3, when the head 26a ejects colored inks while being moved to the left side in the drawing, ejects a transparent ink after colored inks have been ejected. In this way, because the head 26a is provided with the nozzle arrays AL2 and AL3 that eject a transparent ink, when the head 26a ejects colored inks from the nozzle arrays YLa, MLa, CLa, and KLa while being reciprocally moved, it is possible to form an image by ejecting a transparent ink so as to overlap an image formed by ejecting colored inks.

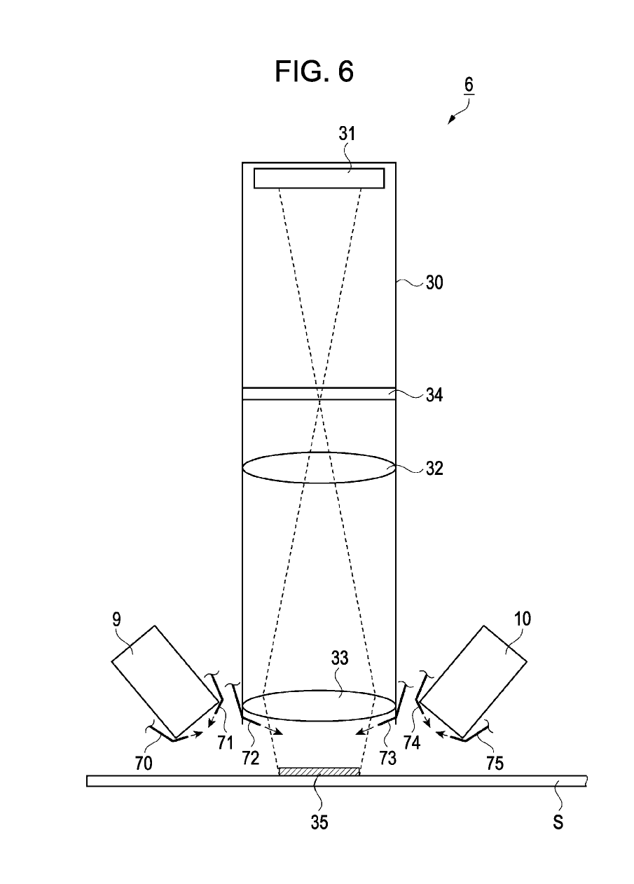

FIG. 6 is a view that illustrates the camera 6 and the irradiation units 9 and 10. A latent image pattern 35 that is formed by ejecting a transparent ink is formed on the sheet of paper S. The irradiation units 9 and 10 are provided respectively on both sides of an enclosure 30 of the camera 6 in the drawing. An ultraviolet ray is irradiated from the irradiation units 9 and 10 toward the latent image pattern 35. Light reflected from the latent image pattern 35 penetrates through a lens 33 and a lens 32 and then enters a CCD 31. At this time, light that natural light is reflected on the latent image pattern 35, peripheral devices, the sheet of paper S, and the like, also enters the lens 33.

A filter 34 that transmits light of a second wavelength range that is different from the wavelength range of an ultraviolet ray is provided between the lens 32 and the CCD 31. In the present embodiment, the filter 34 transmits light of the wavelength range of green, which serves as light of a second wavelength range. Within light that enters from the lens 33, light of the wavelength range of green, penetrating through the filter 34, enters the CCD 31.

Light that has entered the CCD 31 is converted into an electrical signal by the CCD 31. The converted electrical signal is converted into image data by the control unit 107.

Around the lens 33 located at the lower side of the enclosure 30, pipes 72 and 73 that eject gas, such as air, supplied from an air pressure generating unit (not shown) formed of a fan or the like, onto the surface of the lens 33. By ejecting gas from the pipes 72 and 73 as indicated by arrows, it is possible to suppress ink mist or paper particles from the sheet of paper S from being adhered on the surface of the lens 33. Pipes 70 and 71 and pipes 74 and 75 are similarly provided around portions to which the irradiation units 9 and 10 irradiate an ultraviolet ray. Note that the pipes 70, 71, 72, 73, 74, and 75 indicate the distal ends of the respective pipes, and pipe portions connected to the side of the air pressure generating unit are not shown.

An image formation control unit of the ink jet printer 1 ejects colored inks to the sheet of paper S to thereby form a visible image. The image formation control unit includes a printer controller 113 and a print engine 114 that has the head 26 having first nozzles that eject colored inks.

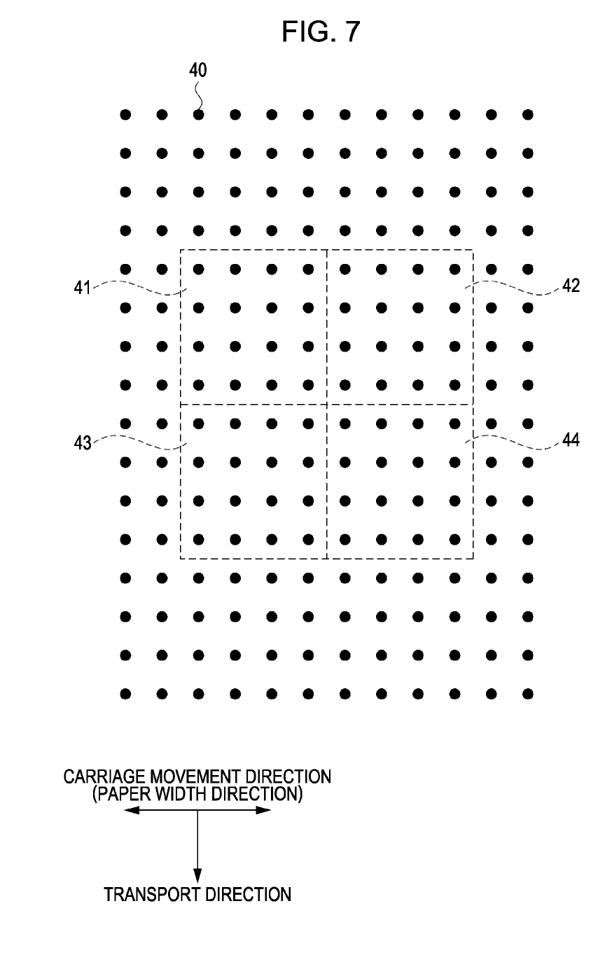

FIG. 7 shows a latent image pattern in which a plurality of marks formed by a latent image formation control unit according to the present embodiment are arranged in a grid. The latent image formation control unit includes the nozzle array AL1 that is formed in the head 26 for ejecting a transparent ink, the printer controller 113 and the print engine 114. The latent image pattern shown in FIG. 7 is a latent image pattern such that a transparent ink is ejected by the latent image formation control unit to arrange a plurality of latent image marks 40 in a grid.

The latent image pattern shown in FIG. 7 shows a portion of an image printed on the sheet of paper S. The latent image pattern is printed at both ends in the paper width direction of the sheet of paper S (carriage movement direction) in FIG. 2, and is printed successively in the transport direction from a position to which the sheet of paper S is fed.

In addition, the latent image pattern shown in FIG. 7 is formed by ejecting a transparent ink so as to overlap a visible image formed by ejecting colored inks. The latent image pattern is a latent image. Thus, even when the latent image pattern is printed so as to overlap a visible image, it is possible to visually recognize the visible image.

Here, the latent image pattern ejected onto the left side end of the sheet of paper S in FIG. 2 and the image field of view of the camera 5 will be described. Areas 41, 42, 43, and 44 surrounded by broken lines are the image field of view of the camera 5. The camera 5 picks up the range shown as the areas 41, 42, 43, and 44 as one image field of view at a time.

The range in the paper width direction in which the marks 40 are arranged in a grid is wider than the range in the width direction of the areas 41, 42, 43, and 44. Thus, even when the image field of view of the camera 5 is shifted in the paper width direction, it is possible to place a predetermined number of marks, arranged in a grid, within one range of the image field of view.

The camera 5 acquires the latent image pattern in the areas 41, 42, 43, and 44 with the CCD 31 as electrical signals to thereby pick up a real image pattern. The control unit 107 converts the electrical signals acquired by the CCD 31 into image data.

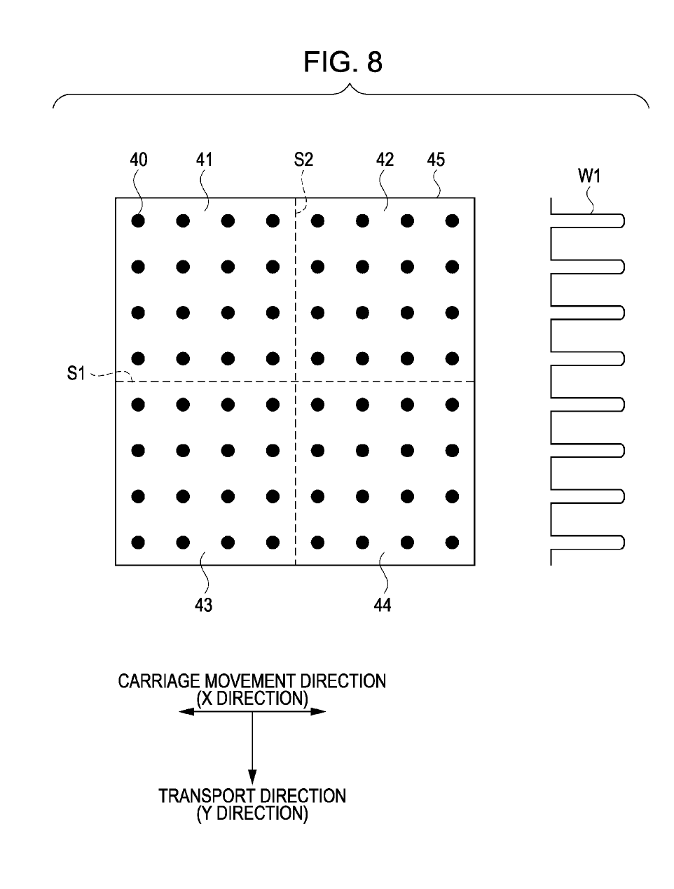

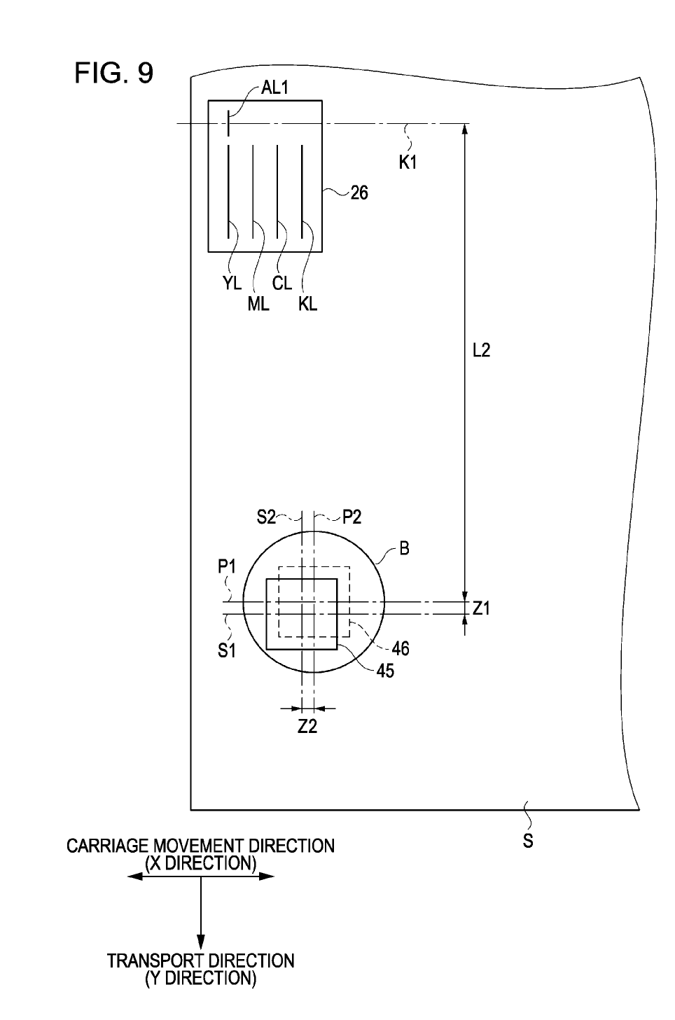

Here, a deviation in amount of feed of the sheet of paper S in the transport direction will be described. The transport direction is defined as a Y direction, and the carriage movement direction is defined as an X direction. FIG. 8 is a view that shows the converted image data. FIG. 9 is a schematic view that illustrates a deviation in amount of feed in the Y direction. The circle shown in FIG. 9 represents the image field of view B of the camera 5. The solid line rectangle represents the range 45 of image data. The broke line rectangle represents the range 46 of temperate data.

The position of the temperate data range 46 in the Y direction represents a position to which movement of the sheet of paper S is repeated in each subscanning in a predetermined amount of feed and the sheet of paper S is ideally transported. The position of the template data range 46 in the X direction represents a position at which, within positions that the head 26 faces the sheet of paper S, the template data are formed in the carriage movement direction, and that is an ideal position in the carriage movement direction. The distance L2 in the Y direction between the center line P1 of the template data range 46 and the center line K1 of the nozzle array AL1 that is formed in the head 26 and that ejects a transparent ink will be held even when the head 26 is reciprocally moved in the carriage movement direction.

A deviation in position in the Y direction between the center line P1 and the center line S1 of the image data range 45, that is, a deviation in amount of feed, is a distance indicated by Z1. A deviation in position in the X direction between the center line P2 of the template data range 46 and the center line S2 of the image data range 45 is a distance indicated by Z2.

The deviation Z1 in amount of feed in the Y direction is a total value obtained by accumulating a deviation between the predetermined amount of feed in one subscanning and the amount of feed that is actually transported in one subscanning, when the sheet of paper S is moved by repeating main scanning. The deviation Z2 in position in the X direction arises because a position landed from the head shifts in the X direction when transported to the position of the camera 5 if the sheet of paper S is inclined.

Next, a method of calculating a deviation in amount of feed in the Y direction will be described. The waveform W1 shown in FIG. 8 is obtained so that a value obtained by adding up image data pixel by pixel in the X direction is calculated as the sum total of levels in the X direction and the value is continuously calculated in the Y direction. The template data, as well as the latent image pattern shown in FIG. 8, are image data of a template pattern such that a plurality of marks including the marks 40 are arranged in the same manner. Thus, the waveform that is obtained so that a value obtained by adding up the template data by pixels in the X direction is calculated as the sum total of levels in the X direction and the value is continuously calculated in the Y direction will be a similar waveform to the waveform W1 shown in FIG. 8.

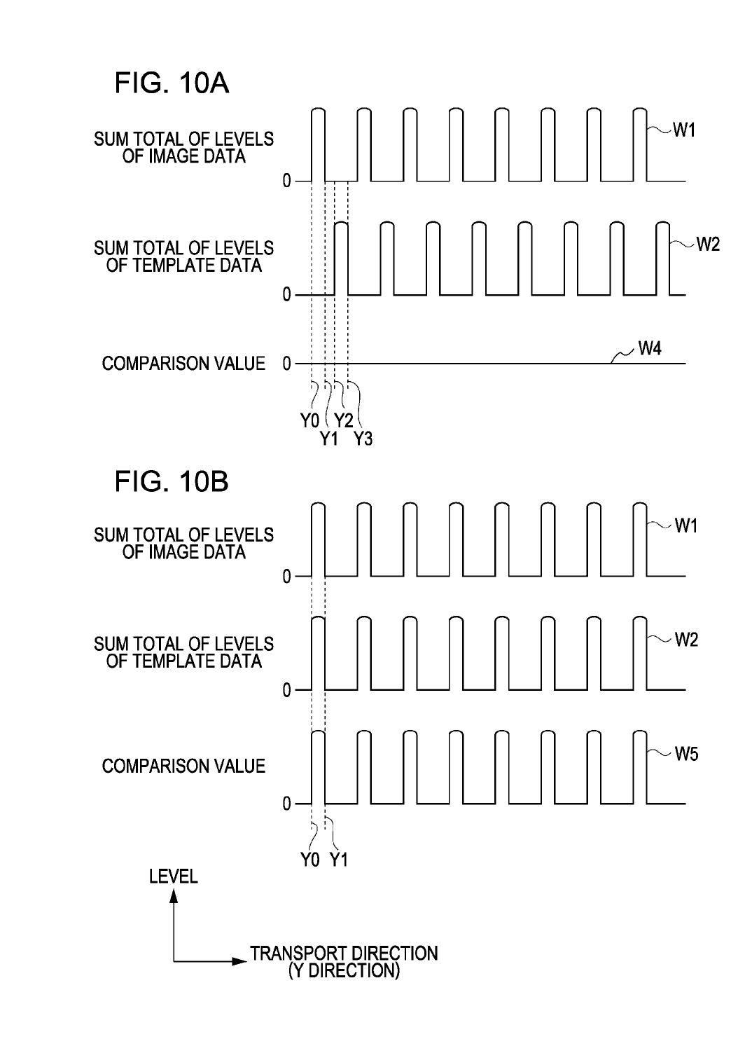

For easy description, description will be made on the assumption that the deviation Z2 in the X direction is zero. FIG. 10A is a view that illustrates a case in which image data and template data do not coincide with each other in position in the Y direction in the image field of view B of the camera 5. At this time, it is assumed that the marks that constitute the image data do not overlap the marks that form the template data in the image field of view B of the camera 5.

The waveform W1 shown in FIG. 10A is the waveform of the sum total of levels of the image data in the X direction and is described with reference to FIG. 8. The waveform W2 is the waveform of the sum total of levels of the template data in the X direction. The waveform W4, which shows comparison values, is calculated at positions in the Y direction by multiplying the value of the waveform W1 by the value of the waveform W2. In each of the waveforms W1, W2, and W4, the abscissa axis in the drawing represents a position in the Y direction, and the ordinate axis represents a signal level. Between the position Y0 to the position Y1 in the Y direction, the sum total of levels of the template data is zero, so that the product is zero. Between the position Y2 to the position Y3 in the Y direction, the sum total of levels of the image data is zero, so that the product is zero. In this manner, when the position of the image data in the Y direction does not coincide with the position of the template data in the Y direction, the product is zero, so that the waveform W4 of comparison values shown in FIG. 10A normally indicates zero.

FIG. 10B is a view that illustrates a case in which image data and template data coincide with each other in position in the Y direction in the image field of view B of the camera 5. In this state, the plurality of marks that constitute the image data overlaps the plurality of marks that constitute the template data in the image field of view B of the camera 5.

At any positions including positions between Y0 to Y1 in the Y direction, the shape of the waveform W1 of the sum total of levels of the image data coincides with the shape of the waveform W2 of the sum total of levels of the template data. Thus, the waveform W5 of comparison values calculated through the product of the sum total of levels of the image data and the sum total of levels of the template data is also generated in a similar shape to the shape of the waveform W1 or the shape of the waveform W2.

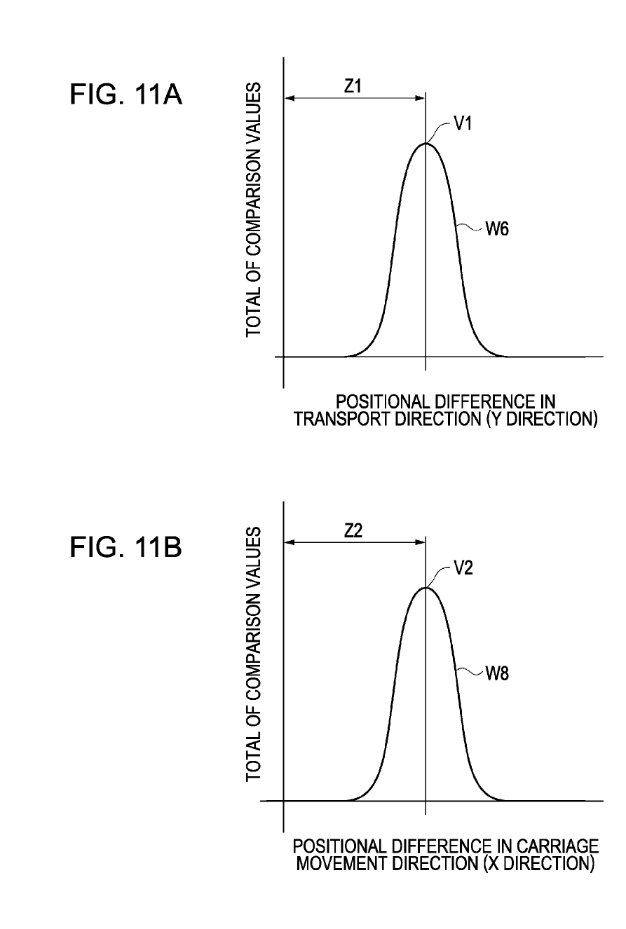

FIG. 11A is a view of the waveform W6 that shows changes in total of comparison values when the position of the image data in the Y direction is shifted within the image field of view B. As is described with reference to FIG. 8 and FIG. 10A, when the position of the range in which marks forming the image data are formed does not overlap the position of the range in which marks forming the template data are formed within the image field of view B of the camera 5, the total of comparison values is zero.

In the image field of view B, when the position of the image data in the Y direction is shifted, the position of the range in which the marks forming the image data are formed initiates to overlap the position of the range in which the marks forming the template data are formed. Thus, the total of comparison values represented in Y-coordinate in FIG. 11A increases. When the overlapped range becomes maximum, that is, when the positions of the marks that form the image data coincide with the positions of the marks that form the template data, the value of the waveform W6 reaches the maximum value V1. The value of the X-coordinate in FIG. 11A when the total of the comparison values reaches the maximum value V1 will be the deviation Z1 in the Y direction shown in FIG. 9.

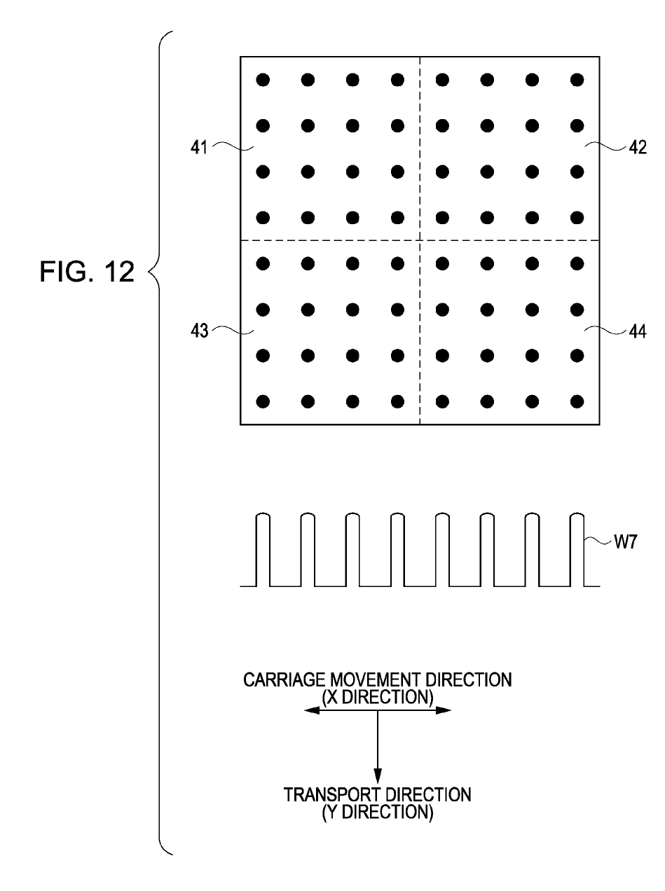

Next, a method of calculating a deviation Z2 in the X direction will be described. FIG. 12 is a view that shows values obtained by totaling the image data pixel by pixel in the Y direction as levels in the Y direction. The waveform W7 shown in FIG. 12 is obtained so that a value obtained by adding up image data pixel by pixel in the Y direction is calculated as the sum total of levels in the Y direction and the value is continuously calculated in the X direction.

FIG. 11B is a view of the waveform W8 that shows changes in total of comparison values when the position of the image data in the X direction is changed within the image field of view B. For easy description, description will be made on the assumption that the deviation Z1 in the Y direction is zero. When the position of the range in which marks forming the image data are formed does not overlap the position of the range in which marks forming the template data are formed within the image field of view B of the camera 5 the total of comparison values is zero. In the image field of view B, when the position of the image data in the X direction is shifted, the position of the range in which the marks forming the image data are formed initiates to overlap the position of the range in which the marks forming the template data are formed. Thus, the total of comparison values represented in Y-coordinate in FIG. 11B increases. When the overlapped range becomes maximum, that is, when the positions of the marks that form the image data coincide with the positions of the marks that form the template data, the value of the waveform W8 reaches the maximum value V2. The value of the X-coordinate in FIG. 11B when the total of the comparison values reaches the maximum value V2 will be the deviation Z2 in the X direction shown in FIG. 9.

For easy description, the description is made so that the deviation Z2 in the X direction is set to zero when describing the deviation Z1 in the Y direction and the deviation Z1 in the Y direction is set to zero when describing the deviation Z2 in the X direction. Actually, in the image field of view B, the deviation Z1 in the Y direction and the deviation Z2 in the X direction are detected at a position at which the total of comparison values shown in FIG. 11A and the total of comparison values shown in FIG. 11B respectively reach the maximum by shifting the positions of the image data in the X direction and in the Y direction.

In this way, the deviation Z1 in the Y direction is detected by a positional difference detection unit to thereby detect the deviation Z1 in amount of feed when the sheet of paper S is moved in the Y direction.

The latent image pattern ejected onto the left side of the sheet of paper S in FIG. 2 and the image field of view B of the camera 5 is described; the latent image pattern ejected onto the right side of the sheet of paper S in the drawing and the image field of view of the camera 6 may also employ the similar manner to thereby make it possible to detect a deviation between the amount of feed that is initially set and the amount of feed that is actually transported. The latent image patterns are ejected onto both ends of the sheet of paper S, and the cameras 5 and 6 are respectively provided on both sides. Thus, it is possible to detect the right or left inclination of sheet of paper S with respect to the longitudinal direction.

Next, the control unit 107 of the printer controller 113 that constitutes the image formation control unit calculates a deviation in amount of feed in one subscanning on the basis of the detected deviation Z1 in amount of feed and the number of times subscanning is performed. Then, the control unit 107 changes a set value of the amount of feed in one subscanning on the basis of the calculated deviation in amount of feed in one subscanning. In this manner, the image formation control unit executes feedback correction control on the amount of movement (amount of feed) in regard to relative movement between the sheet of paper S and the first nozzles on the basis of a deviation in amount of feed, which is a relative position, detected by a position detection unit.

An actuator unit according to the present embodiment includes the control unit 107, the carriage actuating unit 109 and the transport unit 110. The actuator unit performs relative movement between the sheet of paper S, which serves as a recording medium, and nozzles, which serve as the first nozzles, formed in the nozzle arrays YL, ML, CL and KL.

The position detection unit according to the present embodiment includes an imaging unit and the positional difference detection unit. The imaging unit includes the CCD 31, the control unit 107, and the RAM 102 and ROM 103 that are used by the control unit 107 for data processing. The positional difference detection unit includes the control unit 107 and the RAM 102 and ROM 103 that are used by the control unit 107 for data processing.

An image conversion unit of the present embodiment includes the CCD 31, the control unit 107, and the RAM 102 and ROM 103 used by the control unit 107 for data processing.

As described above, it is provided with the first nozzles that eject colored inks, which serve as first liquid droplets, for forming an image on the sheet of paper S, which serves as a recording medium, the second nozzles that eject an ink, which serves as a second droplet, transparent to a visible light for forming a latent image on the sheet of paper S, the actuator unit that performs relative movement between the sheet of paper S and the first nozzles, the image formation control unit that, during the relative movement, ejects colored inks on the sheet of paper S to thereby form an image pattern, the latent image formation control unit that forms a latent image pattern by ejecting a transparent ink onto the sheet of paper S so as to overlap the image pattern, and the position detection unit that recognizes the latent image pattern as a reference position on the sheet of paper S and detects the relative position between the sheet of paper S and the first nozzles. Then, the image formation control unit controls the relative movement on the basis of the relative position detected by the position detection unit.

According to the above configuration, a transparent ink is ejected onto the sheet of paper S so as to overlap an image pattern to thereby form a latent image pattern, the latent image pattern is recognized as a reference position on the sheet of paper S, and a relative position between the sheet of paper S and the first nozzles are detected. Thus, without requiring work time for operating a sheet of paper S to be printed or the liquid ejecting apparatus in advance, it is possible to accurately form an image.

In addition, the position detection unit includes the imaging unit that picks up a latent image pattern as a real image, and the positional difference detection unit that detects a positional difference between the real image pattern and the template pattern in the field of view of the imaging unit. With the above configuration, by detecting the positional difference between the real image pattern and the template pattern, it is possible to detect a deviation in amount of feed.

In addition, the latent image formation control unit controls formation of a latent image pattern so that, after one relative movement is performed, the latent image pattern is located within the field of view of the imaging unit. According to the above configuration, formation of a latent image pattern is controlled so that the latent image pattern is located within the field of view of the imaging unit. By so doing, because the latent image pattern may be picked up as a real image pattern by the imaging unit, it is possible to detect a deviation in amount of feed using the real image pattern.

In addition, the image formation control unit executes feedback correction on the amount of movement in regard to the relative movement. By so doing, because the amount of each feed is corrected, it is possible to improve the accuracy of the amount of feed. Thus, it is possible to improve the quality of an image.

In addition, the latent image formation control unit moves a recording medium in a first direction relatively to a head having second nozzles while ejecting liquid droplets from the head onto the recording medium to thereby form a latent image pattern having a plurality of marks that are arranged successively in a second direction perpendicular to the first direction.

According to the above configuration, owing to the plurality of marks that are arranged successively in the second direction perpendicular to the first direction, it is possible to detect a deviation in amount of feed of the recording medium in the second direction perpendicular to the first direction.

In addition, the ink jet printer 1 of the present embodiment includes the irradiation units 7, 8, 9, and 10 that irradiate an ultraviolet ray, which serves as light of a first wavelength range, to a latent image pattern and the image conversion unit that selectively receives light of a second wavelength range emitted from the latent image pattern through irradiation of the ultraviolet ray and that converts the received light into image data. The second liquid droplets contain a fluorescent substance, which serves as a wavelength conversion material, that, when light of a first wavelength range enters the fluorescent substance, emits light of the second wavelength range that is different from the first wavelength range.

According to the above configuration, light of the second wavelength range emitted from the latent image pattern is selectively received, and is converted into image data. By so doing, it is possible to reduce the influence of natural light or an ultraviolet ray, which serves as light of the first wavelength range, that is reflected around the latent image pattern. Thus, because it is possible to suppress a decrease in quality of the converted image data, it is possible to highly accurately read the position of the latent image pattern formed on the sheet of paper S.

In addition, ink that is ejected from the nozzles formed in the head 26 of the ink jet printer 1 is transparent to visible light. According to the above configuration, by forming a latent image pattern by ejecting a transparent ink so as to overlap a visible image formed on the sheet of paper S, the visible image may be visually recognized. Thus, it is possible to highly accurately read the position of the latent image pattern formed on the sheet of paper S while forming the visible image.

In addition, the image conversion unit of the ink jet printer 1 includes a filter that cuts light of a first wavelength range and that transmits light of a second wavelength range. According to the above configuration, the image conversion unit selectively receives light of the second wavelength range emitted from the latent image pattern to thereby make it possible to reduce the influence of natural light or light of the first wavelength range that is reflected around the latent image pattern.

In addition, the position detection unit, during changes in relative position component between the image data, which are detected data of the marks, and the template data, calculates a variation in the relative position component when the logical product of the image data and the template data takes an extreme value.

According to the above configuration, by calculating a variation in relative position component when the logical product of the image data and the template data takes an extreme value, it is possible to detect a deviation in amount of feed of the recording medium in a second direction perpendicular to the first direction.

In addition, the positional difference detection unit, in the image field of view B of the image conversion unit, detects a difference between the positions of the plurality of marks that constitute the image data and the positions of the template data that are arranged in the same manner as the plurality of marks.

According to the above configuration, by detecting a difference between the positions of the plurality of marks that constitute the image data and the positions of the template data that are arranged in the same manner as the plurality of marks, it is possible to detect a deviation in amount of feed in the transport direction while printing. Thus, the user does not need work time for operating the ink jet printer 1 in order to detect a deviation in amount of feed and correct the deviation in advance, in addition to time for operating the ink jet printer 1 in order to print out a desired image.

### Second Embodiment

In a second embodiment, a method of arranging a plurality of marks that form a latent image pattern in a grid and detecting a deviation in amount of feed of a sheet of paper S in the transport direction will be described. An ink jet printer of the second embodiment has the same configuration as the ink jet printer 1 described in the first embodiment.

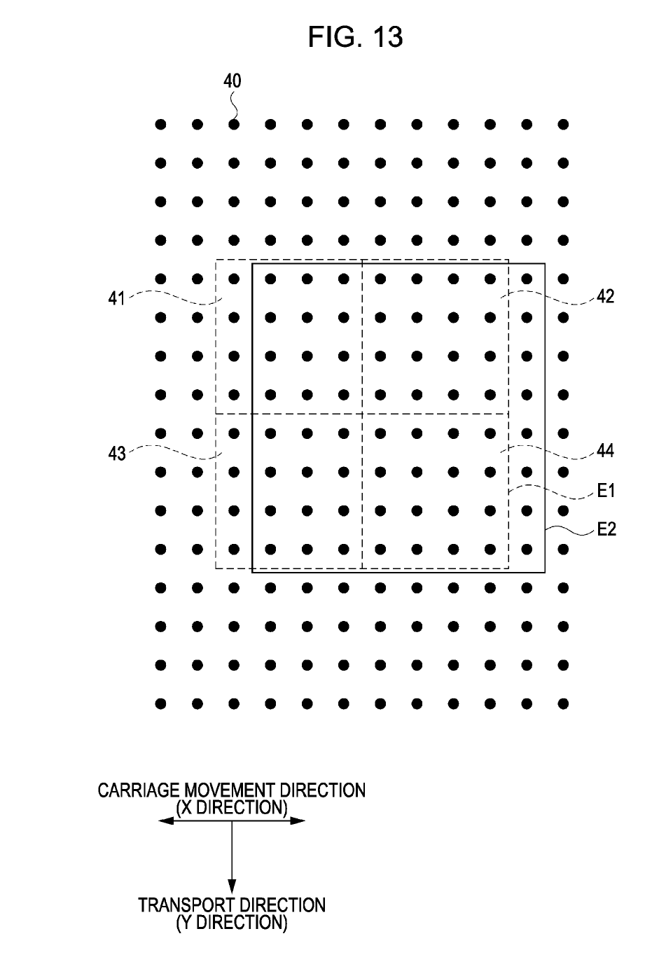

FIG. 13 is a view in which a plurality of marks 40 that constitute a latent image pattern are arranged in the transport direction (Y direction). In addition, in FIG. 13, a plurality of marks are arranged in the X direction and are arranged in a grid at intersections of columns in the Y direction and rows in the X direction. When the deviation Z2 in the X direction is smaller than half the distance between the adjacent marks, the range that is surrounded by broken line rectangle and that includes the areas 41, 42, 43, and 44 will be the range E1 of the latent image pattern that will be converted into image data. When the deviation Z2 in the X direction is larger than the distance between the adjacent marks, the range that is surrounded by solid line rectangle will be the range E2 of the latent image pattern that will be converted into image data. As shown in FIG. 13, the position of the range E2 of the latent image pattern coincides with the position of the range E1 of the latent image pattern in the Y direction; however, the position of the range E2 of the latent image pattern deviates from the position of the range E1 of the latent image pattern to the right side in the drawing by the distance between the adjacent marks in the X direction.

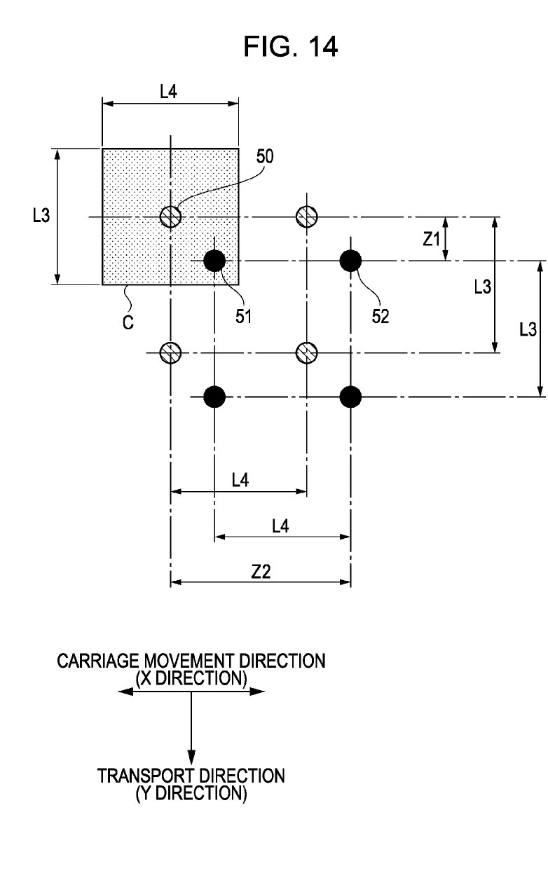

FIG. 14 is a view that illustrates the positions of marks that constitute the image data and the positions of marks that constitute the template data at a portion of the area E2 of the latent image pattern. Solid black circles in FIG. 14 represent marks that constitute the image data converted from the latent image pattern. Diagonally shaded circles represent marks that constitute the template data. The distance in the Y direction between the adjacent marks in the image data and in the template data is L3, and the distance in the X direction between the adjacent marks is L4.

As shown in FIG. 14, the deviation in the Y direction is Z1, and the deviation in the X direction is Z2. Here, the ink jet printer 1 of the present embodiment is able to reduce the deviation Z1 in the Y direction so as to be smaller than half the distance L3 between the adjacent marks. In addition, the deviation Z2 in the X direction, as described with reference to FIG. 13, is larger than the distance L4 between the adjacent marks because the marks are located at positions deviated to the right side in the drawing by the distance between the adjacent marks in the X direction. For example, a mark 52 that is indicated by black circle and that constitutes the image data deviates from a mark 50 that is indicated by diagonally shaded circle to the right side by the deviation Z2 in the X direction.

The shaded rectangle in FIG. 14 represents a range C to which the position of a mark 51 that constitutes the image data is shifted in the X direction and in the Y direction using the mark 50 that constitutes the template data as a reference position. A distance by which the range C is shifted in the Y direction is equal to the distance 13 between the adjacent marks, and a distance by which the range C is shifted in the X direction is the same as the distance L4 between the adjacent marks. As described above, the ink jet printer 1 of the present embodiment is able to reduce the deviation Z1 in the Y direction so as to be smaller than half the distance L3 between the adjacent marks. Thus, the mark 51 is moved by half the distance between the adjacent marks to the upper side or lower side in the drawing using the mark 50 as a reference position, and the position at which the mark 50 coincides with the mark 51 will be a position at which a deviation in amount of feed is detected. Thus, a distance by which the range C is shifted in the Y direction is within the distance between the adjacent marks.

In addition, when the mark 51 is moved within the range of the distance L4 between the adjacent marks in the X direction using the mark 50 as a reference position, it is possible to make the mark 50 coincide with the mark 51. In the X direction, the mark 52 that is located at a position deviated from the mark 50 by the deviation Z2 is not moved so as to coincide with the mark 50 in the X direction, but the relative position in the X direction between the position of the image data and the position of the template data is shifted until the mark 51 coincides with the mark 50.

In this way, when a deviation in the Y direction between the position of the image data and the position of the template data is within half the distance between the adjacent marks, because a plurality of marks are arranged in the transport direction, it is possible to make the image data coincide with the template data so that the amount of movement of the mark 51 in the Y direction is within the distance between the adjacent marks. Thus, by making the image data coincide with the template data, it is possible to shorten processing time for which a deviation in amount of feed is detected.

In addition, because the plurality of marks are arranged in the transport direction, when the sheet of paper S is transported while repeating subscanning, it is possible to successively place a plurality of marks at positions that face the cameras 5 and 6. Thus, within a period from feeding of the sheet of paper S to ejection thereof, during a period in which the latent image pattern is placed at a position that faces the camera 5 or 6, it is possible to detect a deviation in amount of feed over multiple times.

In addition, when a deviation in the X direction between the position of the image data and the position of the template data is within half the distance between the adjacent marks because a plurality of marks are arranged in the X direction, it is possible to shorten processing time for which a deviation in amount of feed in the Y direction is detected in such a manner that the position of the image data is made to coincide with the position of the template data so that the amount of movement in the X direction is within the distance between the adjacent marks.

In this manner, because a plurality of marks are arranged in a grid at intersections of columns in the Y direction and columns in the X direction, when a deviation in the Y direction or in the X direction between the position of the image data and the position of the template data is within half the distance between the adjacent marks, it is possible to make the position of the image data coincide with the position of the template data so that the amount of relative movement in the Y direction or in the X direction between the position of the image data and the position of the template data is within the distance between the adjacent marks in the corresponding direction. Thus, it is possible to shorten processing time for which a deviation in amount of feed in the Y direction is detected.

In addition, as described with reference to FIG. 14, even when the range E2 of the latent image pattern is located at a position deviated to the right side in the drawing by the distance between the adjacent marks in the X direction, it is possible to calculate the deviation Z1 in the Y direction if the distance between the adjacent marks shown as the range C is shifted in the X direction and in the Y direction. Thus, even when the positions in the X direction between the image data and the template data are deviated at the distance between the adjacent marks or more, the deviation Z1 in the Y direction may be detected and, therefore, it is possible to suppress a decrease in detection accuracy.

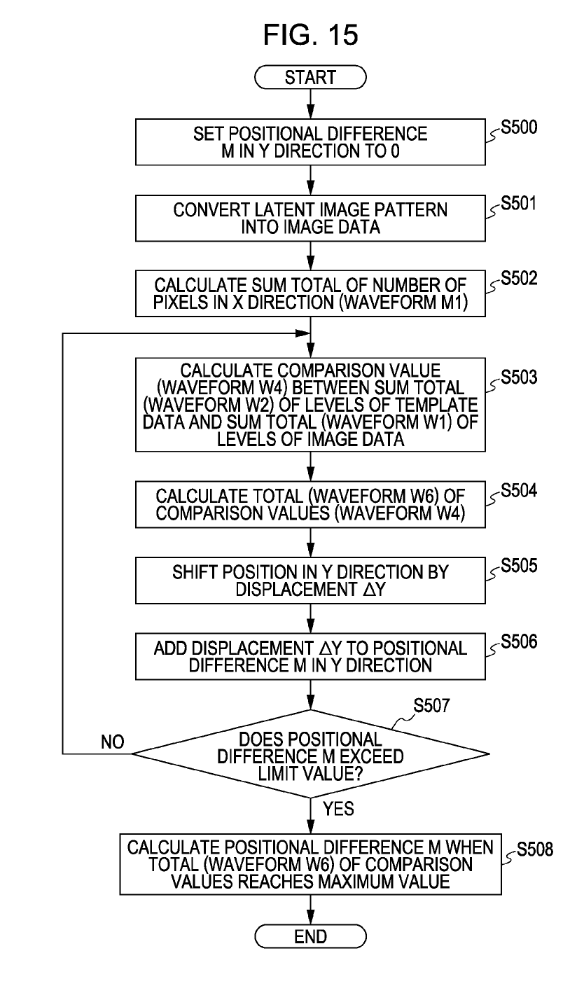

Next, the flow of processes until the deviation Z1 in the Y direction is detected will be described. FIG. 15 is a flowchart that shows the flow of processes until the deviation Z1 in the Y direction is detected. The sum total of levels of the template data shown by the waveform W2 in FIG. 10A is stored in the ROM 103 in advance.

The process is initiated, and in step S500, a positional difference in the Y direction shown in FIG. 11A is set to zero. Here, the positional difference is M. In step S501, a latent image pattern in the areas 41, 42, 43, and 44 shown in FIG. 7 is read by the camera 5 or 6, and the control unit 107 converts the latent image pattern into image data shown in FIG. 8 and stores the image data in the RAM 102. In step S502, the sum total of the number of pixels in the X direction in the image data shown in the waveform W1 in FIG. 8 and FIG. 10A is calculated.

In step S503, the comparison value (waveform W4) is calculated through the product of the sum total (waveform W2) of levels of the template data stored in the ROM 103 and the sum total (waveform W1) of levels of the image data stored in the RAM 102. In step S504, the total (waveform W6 shown in FIG. 11A) of the comparison values (waveform W4) is calculated.

In step S505, the position in the Y direction is shifted by a displacement ΔY. In step S506, the displacement ΔY is added to the positional difference M in the Y direction. In step S507, it is determined whether the positional difference M exceeds a limit value. In the present embodiment, the limit value is set to a distance that is half the distance between the adjacent marks in the Y direction. If the positional difference M exceeds the limit value (Yes), the process proceeds to step S508. If the positional difference M does not exceed the limit value (No), the process returns to step S503.

In step S508, the positional difference M when the total (waveform W6) of the comparison values (waveform W4) reaches the maximum value is calculated. As described above, in FIG. 11A, the positional difference Z1 in the Y direction when the total reaches the maximum value V1 is calculated. In this manner, the positional difference Z1 in the Y direction, that is, the deviation Z1 in amount of feed in the Y direction, is detected.

The processes until the position of the image data coincides with the position of the template data in the X direction are also executed in the similar manner. In this way, the positions in the Y direction and in the X direction are shifted, and the positional difference Z1 in the Y direction when the position of the image data coincides with the position of the template data is calculated.

As described above, the latent image formation control unit of the ink jet printer according to the second embodiment forms a latent image pattern such that a plurality of marks are arranged in a grid in the transport direction and in the vertical direction.

According to the above configuration, by arranging the plurality of marks in a grid in the transport direction and in the vertical direction, it is possible to detect a relative position between the image data and the template data as a deviation in the transport direction and in the vertical direction relative to the transport direction. By so doing, it is possible to detect a deviation in amount of feed of a recording medium in the transport direction and a deviation in amount of feed of the recording medium in the vertical direction relative to the transport direction.

### Third Embodiment

In a third embodiment, a case in which a latent image pattern is formed of a plurality of mark groups will be described. An ink jet printer of the third embodiment has the same configuration as the ink jet printer 1 described in the first embodiment.

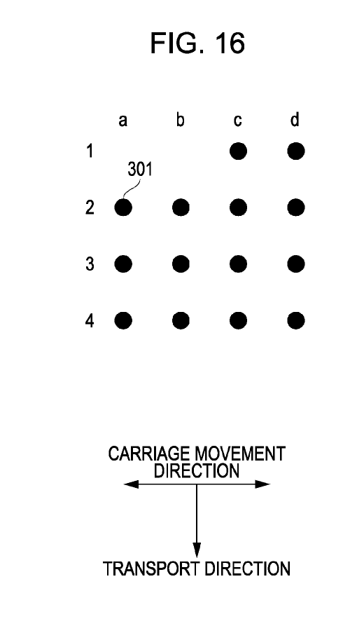

FIG. 16 is a view that shows a plurality of marks 301 that constitute a cluster as one group. In FIG. 16, the columns a to d represent columns in the transport direction, and the rows 1 to 4 represent rows in the carriage movement direction. The number of marks in the column 1 is two, and four marks are arranged in each of the columns 2 to 4.

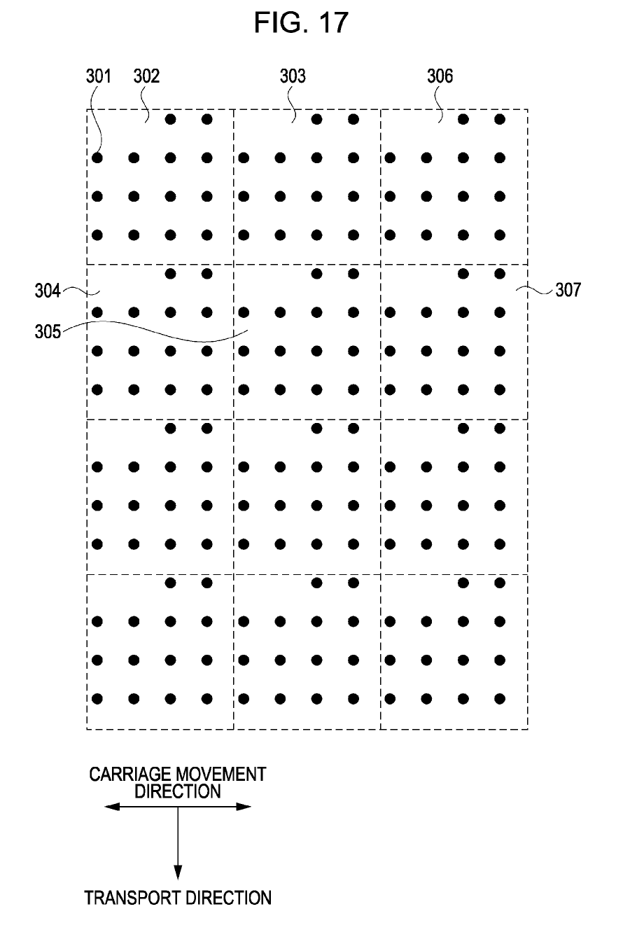

FIG. 17 is a view that shows a latent image pattern formed on a sheet of paper S. The latent image pattern shown in FIG. 17 is formed at each end of the sheet of paper S and is successively formed in the transport direction. The latent image pattern shown in FIG. 17 is formed of a plurality of clusters described with reference to FIG. 16, and the positions of the plurality of marks in each cluster are formed in the same arrangement. Clusters 302, 303, 304, and 305 are picked up from the image field of view B at a time. Then, the clusters 302, 303, 304, and 305 are converted into image data by the image conversion unit.

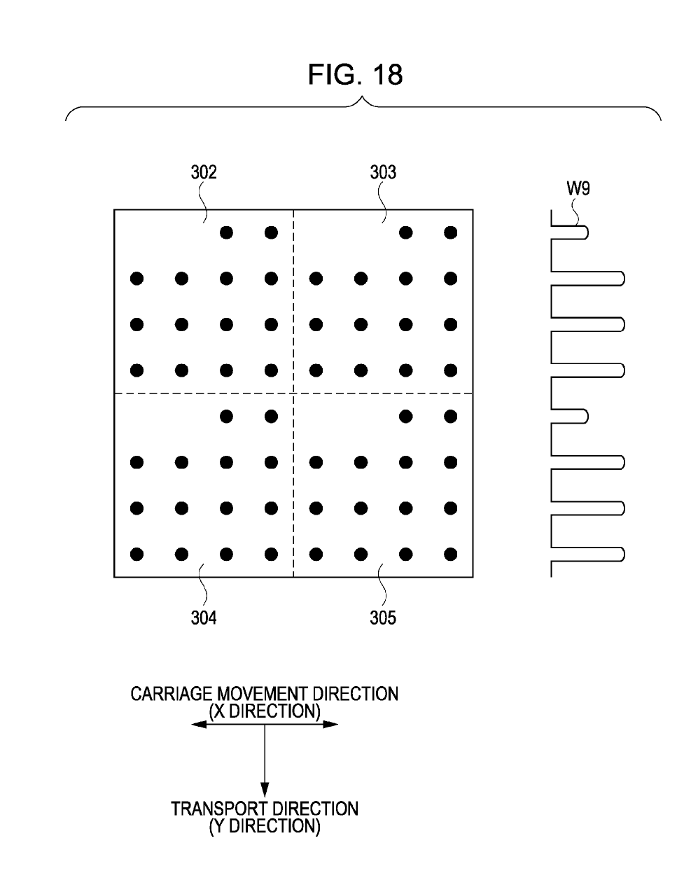

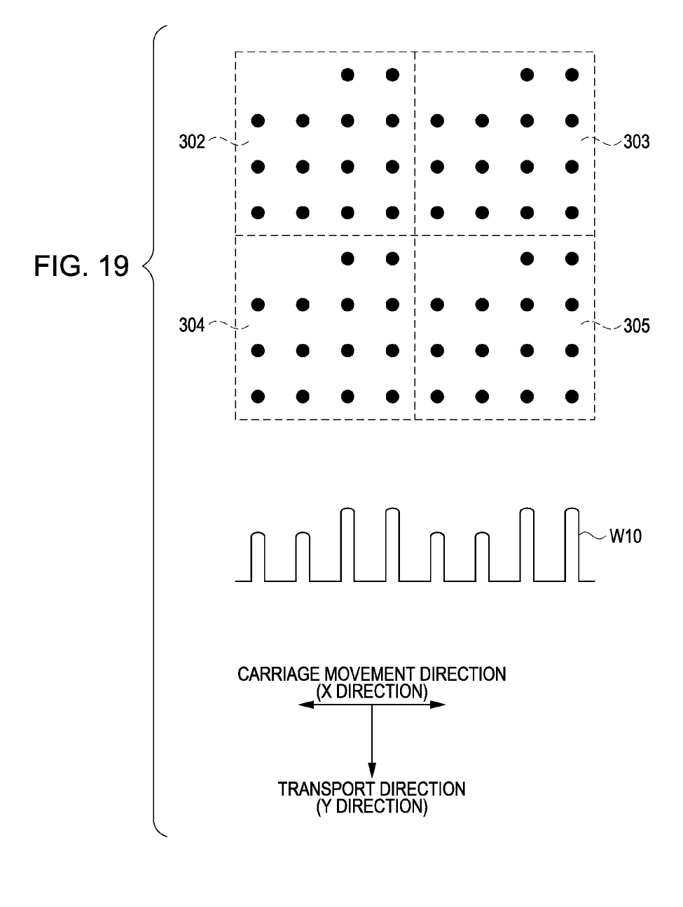

FIG. 18 is a view that shows the converted image data and the waveform of the sum total of levels in the X direction. As described in the first embodiment, the waveform W9 is formed so that the sum total pixel by pixel in the X direction is formed as the sum total of levels in the X direction. FIG. 19 is a view that shows the converted image data and the waveform of the sum total of levels in the Y direction. The waveform W10 is formed so that the sum total pixel by pixel in the Y direction is also formed as the sum total of levels in the Y direction.

As described with reference to FIG. 10 in the first embodiment, in the third embodiment as well, comparison values that are obtained through the product of the sum total of levels in the X direction or in the Y direction in the image data and the sum total of levels in the template data are calculated. Then, as described with reference to FIG. 11 in the first embodiment, the positions of the image data in the X direction and in the Y direction are shifted, a position at which the total of comparison values in the X direction and in the Y direction reaches the maximum value is calculated, and a deviation in the Y direction, that is, the deviation Z1 in amount of feed in the Y direction, is calculated.

The ink jet printer according to the present embodiment is able to set the deviation Z1 in amount of feed in the Y direction to within the range of one cluster.

As described in the third embodiment, the latent image formation control unit forms a latent image pattern formed of a plurality of mark groups, arranges marks so that, in a plurality of columns or rows in the same direction in each mark group, the number of marks in at least one column or row is different from the number of marks in the other columns or rows, and then the positional difference detection unit calculates the sum total of the pixels picked up from the image field of view B in the same direction.

In this manner, by calculating the sum total of pixels of the image field of view B in the same direction, the sum total of pixels in at least one column or row is different from the sum total of pixels in other columns or rows. Thus, it is possible to recognize the boundary between the adjacent mark groups. As a result, even when a deviation in amount of feed exceeds half the distance between the adjacent marks, it is possible to detect the deviation Z1 in amount of feed in the transport direction.

In addition, when the deviation Z2 in the X direction extends over the distance of the width of a plurality of clusters in the X direction, it is possible to detect the deviation Z1 in the Y direction. For example, it is assumed that the range of the image data that are picked up from the image field of view B is the range of the clusters 303, 306, 305, and 307 shown in FIG. 17. It is assumed that these clusters 303, 306, 305, and 307 are located at positions that are deviated to the right side in the drawing by one cluster in the X direction.

In such a case, a deviation in the X direction calculated through the above described method will be a distance that is smaller by one cluster than the actual deviation Z2 in the X direction; however, the calculated deviation in the Y direction coincides with the actual deviation Z1. Thus, even when a deviation in the X direction is located at a position deviated to the right side in the drawing by one cluster, it is possible to detect the deviation Z1 in the Y direction when a difference in position between the image data and the template data in the image field of view B is detected. Thus, it is possible to suppress a decrease in detection accuracy.

As described above, the latent image formation control unit of the ink jet printer according to the third embodiment forms a latent image pattern formed of a plurality of mark groups, arranges the marks so that, in a plurality of columns or rows in the same direction in each mark group, the number of marks in at least one column or row is different from the number of marks in the other columns or rows, and the positional difference detection unit calculates the sum total of pixels picked up from the image field of view B in the same direction.

According to the above configuration, by calculating the sum total of pixels of the image field of view B in the same direction, the sum total of pixels in at least one column or row is different from the sum total of pixels in the other columns or rows. Thus, it is possible to recognize the at least one column or row that is different in number of marks from the other columns or rows. By so doing, it is possible to detect a deviation in amount of feed of a recording medium in the transport direction and a deviation in amount of feed of the recording medium in the vertical direction relative to the transport direction.

In addition, the positional difference detection unit calculates comparison values by performing the product of the sum total of image data and the sum total of template data at the same position in the transport direction, shifts a relative position between the image data and the template data, and calculates a displacement by which the relative position is shifted to a position at which the total of the comparison values reaches the maximum value.

According to the above configuration, by calculating a displacement by which the relative position is shifted to a position at which the comparison values reach the maximum value, in the image field of view B, a displacement from a position at which the image data deviate from the template data to a position at which the image data coincide with the template data, that is, a positional difference, is calculated. By so doing, it is possible to detect a deviation in amount of feed of a recording medium in the transport direction and a deviation in amount of feed of the recording medium in the vertical direction relative to the transport direction.

### Fourth Embodiment

In a fourth embodiment, a case in which mark groups formed in a latent image pattern are identified will be described. An ink jet printer of the fourth embodiment has the same configuration as the ink jet printer 1 described in the first embodiment.

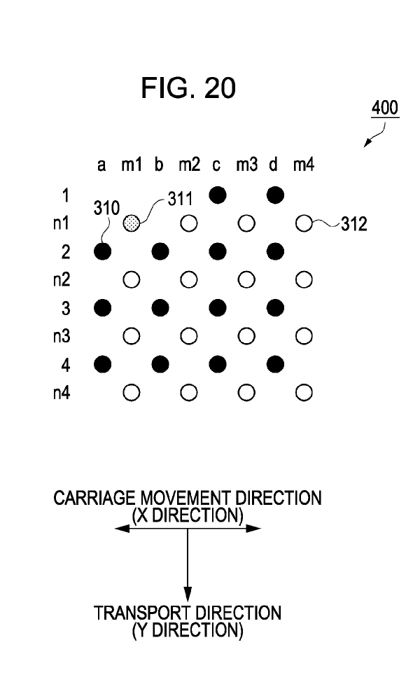

FIG. 20 is a view showing that a mark 311 by which a cluster is identified is formed in a cluster 400, which serves as a group of marks. In FIG. 20, the columns a to d, and m1 to m4 represent columns in the Y direction, and the rows 1 to 4 and n1 to n4 represent rows in the X direction. A plurality of marks 310 indicated by black circles are formed by ejecting ink, and constitute a cluster 400 as one group. In a plurality of columns or rows in the same direction in the cluster 400, as described in the third embodiment, the number of marks in at least one column or row is different from the number of marks in the other columns or rows.

The position of the mark 311 that is indicated by shaded circle and at which the column m1 intersects with the row n1 and the positions of a plurality of white circles, including marks 312, that are indicated by white circles and at which the columns m2 to m4 intersect with the rows n2 to n4 are positions provided for identifying a cluster. The mark 311 is formed by ejecting ink, and a plurality of white circle positions represent that they remain blank and no ink is ejected thereto. The mark 311 is formed by ejecting ink for identifying the cluster 400.

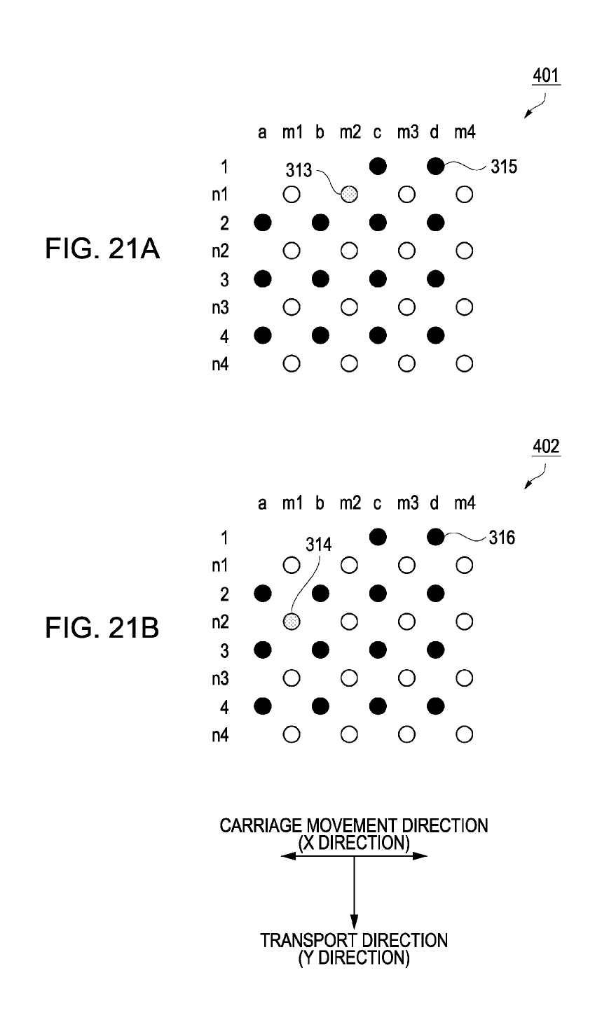

FIG. 21A is a view showing that a mark by which a cluster 401 is identified is formed in the cluster 401. In the cluster 401, a mark 313 that is indicated by shaded circle for identification by ejecting ink is formed at the position at which the column m2 intersects with the row n1. Other positions indicated by white circles represent that they remain blank and no ink is ejected thereto.

FIG. 21B is a view showing that a mark by which a cluster 402 is identified is formed in the cluster 402. In the cluster 402, a mark 314 that is indicated by shaded circle for identification by ejecting ink is formed at the position at which the column m1 intersects with the row n2. Other positions indicated by white circles represent that they remain blank and no ink is ejected thereto. The arrangement of the plurality of marks 315 indicated by black circles in FIG. 21A is the same as the arrangement of the plurality of marks 316 indicated by black circles in FIG. 21B.

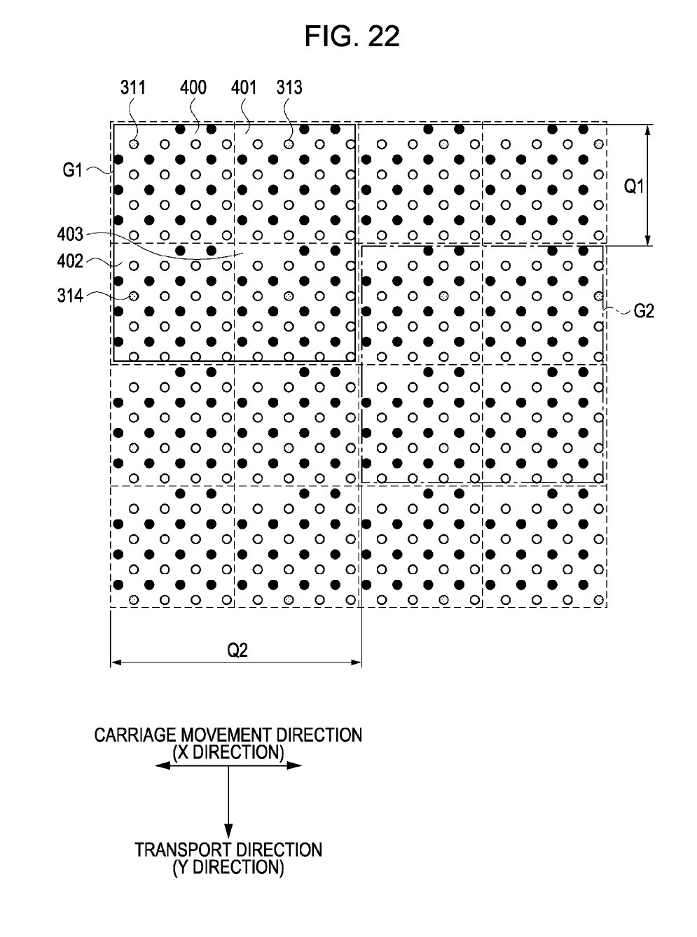

FIG. 22 is a view that shows a latent image pattern formed at each end portion of a sheet of paper S in the X direction. As described above, in the clusters 400, 401, and 402 shown in FIG. 22, the marks 311, 313, and 314 by which a cluster is identified on the basis of the position of the mark formed are respectively formed. In this way, in each cluster shown in FIG. 22, the mark by which each cluster is identified on the basis of the position of the mark formed is formed. The arrangement of the plurality of marks indicated by black circles in each cluster is the same.

The range indicated by a wide solid line rectangle in FIG. 22 is a range G1 of image data that are picked up from the image field of view B of the camera 5 or 6. The range indicated by a narrow long and short dashed line rectangle in FIG. 22 represents a range G2 located at a position to which the range G1 in FIG. 22 is shifted to the lower side in the drawing by a distance Q1 of the width of one cluster in the Y direction and to the right side in the drawing by a distance Q2 of the width of two clusters in the X direction.

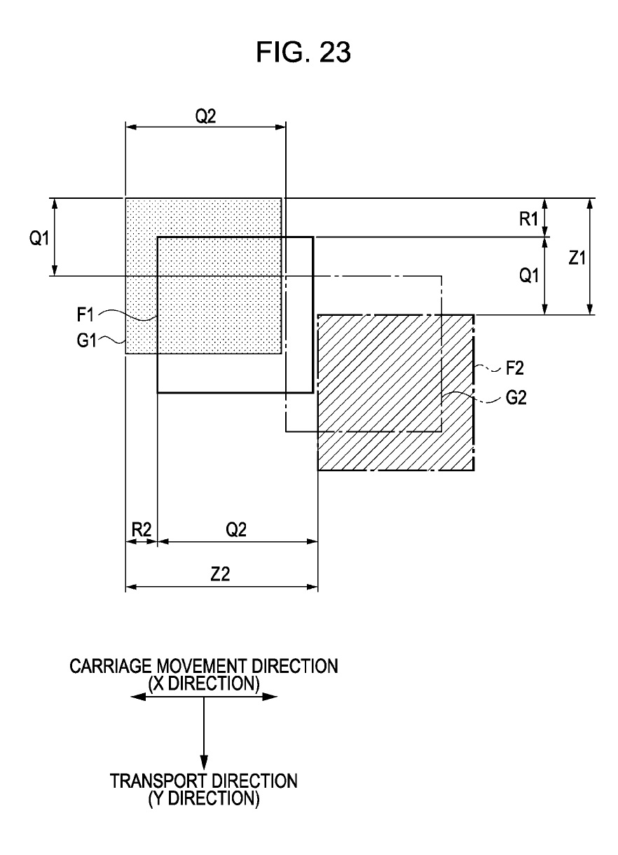

FIG. 23 is a view that illustrates a method by which the deviation Z1 in the Y direction is detected according to the present embodiment. FIG. 23 shows the range G1 of the image data in FIG. 22 and the range G2 that is located at a position to which the range G1 of the image data is shifted to the lower side in the drawing by the distance Q1 of the width of one cluster in the Y direction and to the right side in the drawing by the distance Q2 of the width of two clusters in the X direction.

The rectangular range F1 surrounded by wide solid line in FIG. 23 represents the range of the template data. The arrangement of the marks in the range F1 of the template data is the same as the arrangement of the marks in the range G1 in FIG. 22. The rectangular range F2 that is indicated by oblique lines and that is surrounded by wide long and short dashed line in FIG. 23 represents the range of the template data. The arrangement of the marks in the range F2 of the template data is the same as the arrangement of the marks in the range G2 in FIG. 22.

The range F2 shown in FIG. 23 is located at a position to which the range F1 is shifted to the lower side in the drawing by a distance Q1 of the width of one cluster in the Y direction and to the right side in the drawing by a distance Q2 of the width of two clusters in the X direction.

In the present embodiment, it is assumed that the range F2 of the template data, indicated by oblique lines in FIG. 23, is located at a reference position shown as the range 46 of the template data in FIG. 9.

The positional difference detection unit calculates a deviation R1 in the Y direction and a deviation R2 in the X direction on the basis of portion of image data in the diagonally shaded range G1 of the image data and portion of template data in the range F1 of the template data.

In regard to a deviation between the range F2 of the template data located at the reference position and the range G1 of the image data, as shown in FIG. 23, the deviation Z1 in the Y direction will be a total value of the deviation R1 in the Y direction and the distance Q1 of the width of one cluster in the Y direction. Similarly, the deviation Z2 in the X direction will be a total value of the deviation R2 in the X direction and the distance Q2 of the width of two clusters in the X direction.

In this manner, in the Y direction, when the deviation R1 between the range G1 of the image data and the range F1 of the template data is added to the distance Q1 between the range F1 of the template data and the range F2 of the template data, it is possible to detect the deviation Z1 in the Y direction. Similarly, in the X direction, when the deviation R2 between the range G1 of the image data and the range F1 of the template data is added to the distance Q2 between the range F1 of the template data and the range F2 of the template data, it is possible to detect the deviation Z2 in the X direction.

As described in the fourth embodiment, the latent image formation control unit of the ink jet printer according to the fourth embodiment arranges a mark, which is different from a plurality of marks that are formed in the same arrangement among a plurality of mark groups, at a different position among the mark groups.

According to the above configuration, by arranging the mark at a different position among each mark group, it is possible to separately identify a mark group. Thus, in the transport direction, even when a deviation in amount of feed exceeds a distance of one mark group in the transport direction, it is possible to detect the amount of feed.

In addition, as in the present embodiment, even when the deviation Z2 in the X direction is a distance over a plurality of clusters, because it is possible to detect the deviation Z1 in the Y direction, it is possible to suppress a decrease in detection accuracy.

Furthermore, even when no image data having the same arrangement of marks of the template data in the range F2 are picked up from the image field of view B of the camera 5 or 6, it is possible to detect the deviation Z1 in the Y direction and the deviation Z2 in the X direction. Thus, because it is not necessary to expand the range of the image field of view B, it is possible to suppress an increase in cost of the cameras 5 and 6.

In the first embodiment to the fourth embodiment, a transparent ink is ejected to form a plurality of marks; instead, a low visible ink such as yellow may be ejected to form a plurality of marks.

### Fifth Embodiment

In a fifth embodiment, a case in which a head position changing unit that changes the position of the head in the transport direction is provided will be described. The fifth embodiment differs from the first embodiment in that a head position changing unit that changes the position of the head in the transport direction is additionally provided for the ink jet printer 1.

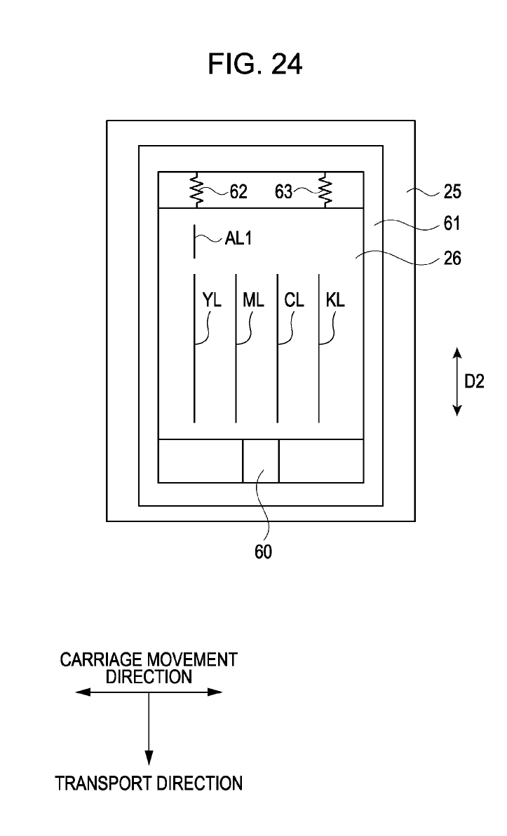

FIG. 24 is a view showing that a piezoactuator that moves the head 26 in the transport direction is provided. The head 26 having the nozzle arrays YL, ML, CL, BL, and AL1 is able to slide the inside of a support member 61 fixed to the carriage 25 in the transport direction indicated by D2. The head 26 contacts the piezoactuator 60 and is applied with pressing force by springs 62 and 63 downward in the drawing.

As a voltage is applied to the piezoactuator 60 by the control unit 107 shown in FIG. 3, mechanical displacement of the piezoactuator 60 causes the distance, in the transport direction, of the piezoactuator 60 that contacts the head 26 to vary. Thus, the head 26 is moved in the transport direction to thereby change a relative position between the head 26 and the sheet of paper S.

The head position changing unit according to the present embodiment includes the piezoactuator 60, the springs 62 and 63, and the support member 61.

The ink jet printer described in the fifth embodiment includes the head position changing unit that changes the position of the head 26 in the transport direction.

In this manner, when visible inks are ejected from the nozzle arrays YL, ML, CL, and BL to form an image on the sheet of paper S, it is possible to move the head 26 in the transport direction on the basis of the deviation Z1 in amount of feed in the transport direction, which is detected by the positional difference detection unit. Thus, a visible image is formed on the sheet of paper S while the deviation Z1 in amount of feed of the sheet of paper S in the transport direction is detected, the position of the head 26 in the transport direction is moved through the control unit 107, and the occurrence of a white stripe or uneven color may be suppressed to arise in a visible image.

### Sixth Embodiment

In a sixth embodiment, a case in which the function of rotating the head 26 is additionally provided for the head position changing unit described in the fifth embodiment will be described.

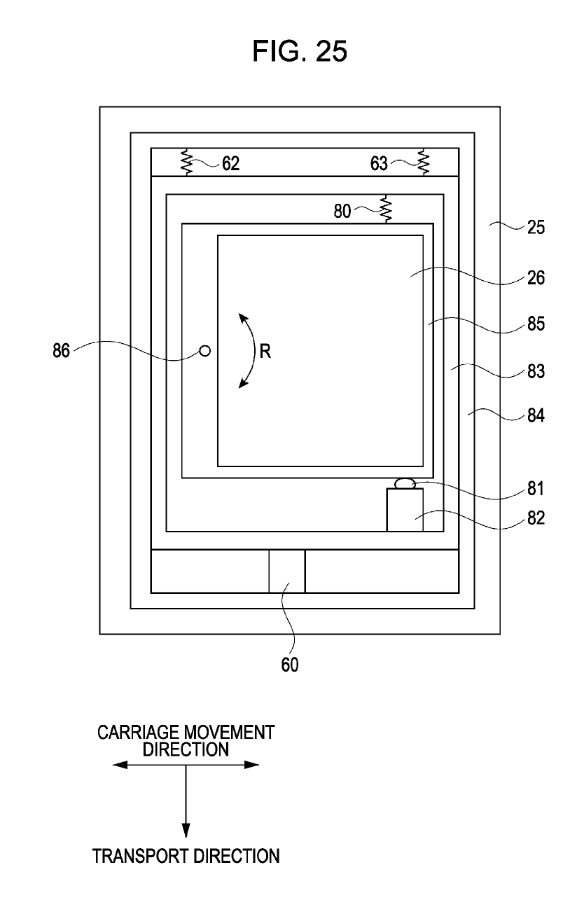

FIG. 25 is a view showing that the function of rotating the head 26 is additionally provided for the head position changing unit described in the fifth embodiment. The head 26 having nozzle arrays (not shown) in the transport direction is fixed to a head fixing plate 85. A pin 86 is fixed to the bottom face of a box-shaped head receiving box 83 having an opening on the front side in the drawing, and the head fixing plate 85 is able to freely rotate about the pin 86 as shown in the rotating direction R. A piezoactuator 82 is provided so as to contact the head fixing plate 85 via a spherical member 81. A spring 80 is provided so as to be held between the head fixing plate 85 and the head receiving box 83, and a pressing force is applied to the head fixing plate 85 and the head receiving box 83 by the spring 80.

As a voltage is applied to the piezoactuator 82 by the control unit 107 shown in FIG. 3, mechanical displacement of the piezoactuator 82 causes the head fixing plate 85 that contacts the head 26 to rotate about the pin 86. Thus, the head 26 fixed to the head fixing plate 85 also rotates in the rotating direction R.

The piezoactuator 60 and the springs 62 and 63 are provided outside the head receiving box 83, and a pressing force is regularly applied to the head receiving box 83 by the springs 62 and 63. The head receiving box 83 is able to slide in the transport direction along the inside of the support member 84.

In this manner, it is possible to incline the nozzle arrays formed in the head 26 with respect to the transport direction. By so doing, it is possible to change a nozzle pitch in the transport direction. Thus, a visible ink is ejected to form an image while the occurrence of a white stripe or uneven color may be suppressed.

In the first embodiment to sixth embodiment, a transparent ink that contains a fluorescent substance, which serves as a wavelength conversion material, that emits green light when an ultraviolet ray is irradiated thereto is ejected onto the sheet of paper S to thereby form a latent image pattern; instead, another method may be employed in which a transparent ink that contains micro magnetic particles is ejected onto the sheet of paper S to thereby form a latent image pattern and then the latent image pattern is detected by a Hall element, which is a magnetic sensor.

The technology described above may be applied to a case in which liquid bubbles are generated in a nozzle by means of electric heating element and then liquid is ejected using the bubbles.

In addition, the technology described above may be applied to various industrial apparatuses other than a printer that performs printing by ejecting ink onto a sheet of paper, or the like. The industrial apparatuses may include a textile printing apparatus that prints a pattern on a color filter or a cloth, a liquid body ejecting apparatus that ejects a liquid body that contains materials, such as electrode materials or color materials, used for manufacturing a liquid crystal display, an electroluminescence (EL) display, or the like, through dispersion or solution, and the like.

What is claimed is:

1. A liquid ejecting apparatus comprising:
a first nozzle that ejects a first liquid droplet for forming an image on a recording medium;
a second nozzle that ejects a second liquid droplet that is transparent to visible light for forming a latent image on the recording medium;
an actuator unit that performs relative movement between the recording medium and the first nozzle;
an image formation control unit that, during the relative movement, ejects the first liquid droplet onto the recording medium to thereby form an image pattern;
a latent image formation control unit that ejects the second liquid droplet onto the recording medium so as to overlap the image pattern to thereby form a latent image pattern; and
a position detection unit that recognizes the latent image pattern as a reference position on the recording medium and that detects a relative position between the recording medium and the first nozzle, wherein
the image formation control unit controls the relative movement on the basis of the relative position detected by the position detection unit.

2. The liquid ejecting apparatus according to claim 1, wherein the position detection unit includes an imaging unit that picks up the latent image pattern as a real image pattern and a positional difference detection unit that, in a field of view of the imaging unit, detects a positional difference between the real image pattern and a template pattern.

3. The liquid ejecting apparatus according to claim 2, wherein the latent image formation control unit controls formation of the latent image pattern so that the latent image pattern is located within the field of view of the imaging unit after one relative movement is performed.

4. The liquid ejecting apparatus according to claim 1, wherein the image formation control unit executes feedback correction of the amount of movement in regard to the relative movement.

5. The liquid ejecting apparatus according to claim 1, further comprising:
an irradiation unit that irradiates light of a first wavelength range to the latent image pattern; and
an image conversion unit that selectively receives light of a second wavelength range, which is emitted from the latent image pattern by irradiating light of the first wavelength range, and that converts the received light of the second wavelength range into image data, wherein
the second liquid droplet contains a wavelength conversion material that, when light of the first wavelength range enters the wavelength conversion material, emits light of the second wavelength range that is different from the first wavelength range.

6. The liquid ejecting apparatus according to claim 5, wherein the wavelength conversion material is a fluorescent substance.

7. The liquid ejecting apparatus according to claim 5, wherein light of the first wavelength range is an ultraviolet ray.

8. The liquid ejecting apparatus according to claim 5, wherein the image conversion unit cuts light of the first wavelength range and transmits light of the second wavelength range.

9. The liquid ejecting apparatus according to claim 5, wherein the latent image formation control unit relatively moves the recording medium in a first direction with respect to a head in which the second nozzle is provided while ejecting a liquid droplet from the head onto the recording medium to thereby form the latent image pattern that includes a plurality of marks arranged successively in a second direction perpendicular to the first direction.

10. The liquid ejecting apparatus according to claim 9, wherein the position detection unit, during changes in relative position component between the image data, which are detected data of the marks, and template data, calculates a variation in the relative position component when the logical product of the image data and the template data takes an extreme value.

11. A liquid ejecting method comprising:
ejecting a first liquid droplet from a first nozzle onto a recording medium for forming an image;
ejecting a second liquid droplet, which is transparent to visible light, from a second nozzle onto the recording medium for forming a latent image;
performing relative movement between the recording medium and the first nozzle;
during the relative movement, ejecting the first liquid droplet onto the recording medium to form an image pattern;
ejecting the second liquid droplet onto the recording medium so as to overlap the image pattern to form a latent image pattern; and
recognizing the latent image pattern as a reference position on the recording medium and detecting a relative position between the recording medium and the first nozzle, wherein
when the image pattern is formed on the recording medium, the relative movement is controlled on the basis of the detected relative position.

12. The liquid ejecting method according to claim 11, further comprising:
irradiating light of a first wavelength range to the latent image pattern; and
selectively receiving light of a second wavelength range, which is emitted from the latent image pattern by irradiating light of the first wavelength range, and then converting light of the second wavelength range into image data, wherein
the second liquid droplet contains a wavelength conversion material that, when light of the first wavelength range enters the wavelength conversion material, emits light of the second wavelength range that is different from the first wavelength range.
